(19) United States
(12) Patent Application Publication
(10) Pub. No.: US 2024/0158174 A1
(43) Pub. Date: May 16, 2024

(54) LOGISTICS AUTONOMOUS VEHICLE WITH ROBUST OBJECT DETECTION, LOCALIZATION AND MONITORING

(71) Applicant: Symbotic LLC, Wilmington, MA (US)

(72) Inventors: Seth Daniel Bruder, Cambridge, MA (US); Husain Al-Mohssen, Wilmington, MA (US)

(21) Appl. No.: 18/507,854

(22) Filed: Nov. 13, 2023

Related U.S. Application Data
(60) Provisional application No. 63/383,597, filed on Nov. 14, 2022.

(51) Int. Cl. B65G 1/137; B65G 1/04; B66F 9/06; B66F 9/075; G06T 7/593; G06T 7/73

(52) U.S. Cl. CPC B65G 1/1378; B65G 1/0492; B66F 9/063; B66F 9/0755; G06T 7/593; G06T 7/73; G06T 2207/10021; G06T 2207/30252

(57) ABSTRACT

An autonomous guided vehicle comprising a frame with a payload hold and a drive section coupled to the frame with drive wheels supporting the autonomous guided vehicle on a traverse surface, the drive wheels effect vehicle traverse on the traverse surface moving the autonomous guided vehicle over the traverse surface in a facility with a payload handler coupled to the frame configured to transfer a payload, with a flat undeterministic seating surface seated in the payload hold, to and from the payload hold of the autonomous guided vehicle and a storage location, of the payload. In a storage array with a vision system mounted to the frame, having more than one camera disposed to generate binocular images of a field of a logistic space including rack structure shelving on which more than one objects are stored and a controller, communicably connected to the vision system to register the binocular images.

### CROSS-REFERENCE TO RELATED APPLICATIONS

This application is a non-provisional of and claims the benefit of U.S. provisional patent application No. 63/383,597 filed on Nov. 14, 2022, the disclosure of which is incorporated herein by reference in its entirety.

### BACKGROUND

### 1. Field

The disclosed embodiment generally relates to material handling systems, and more particularly, to transports for automated logistics systems.

### 2. Brief Description of Related Developments

Generally, automated logistics systems, such as automated storage and retrieval systems, employ autonomous vehicles that transport goods within the automated storage and retrieval system. These autonomous vehicles are guided throughout the automated storage and retrieval system by location beacons, capacitive or inductive proximity sensors, line following sensors, reflective beam sensors and other narrowly focused beam type sensors. These sensors may provide limited information for effecting navigation of the autonomous vehicles through the storage and retrieval system or provide limited information with respect to identification and discrimination of hazards that may be present throughout the automated storage and retrieval system.

The autonomous vehicles may also be guided throughout the automated storage and retrieval system by vision systems that employ stereo or binocular cameras. However, the binocular cameras of these binocular vision systems are placed relative, to each other, at distances that are unsuitable for warehousing logistics case storage and retrieval. In a logistics environment the stereo or binocular cameras may be impaired or not always available due to, e.g., blockage or view obstruction (by, for example, payload carried by the autonomous vehicle, storage structure, etc.) and/or view obscurity of one camera in the pair of stereo cameras; or image processing may be degraded from processing of duplicate image data or images that are otherwise unsuitable (e.g., blurred, etc.) for guiding and localizing the autonomous vehicle within the automated storage and retrieval system.

### BRIEF DESCRIPTION OF THE DRAWINGS

The foregoing aspects and other features of the disclosed embodiment are explained in the following description, taken in connection with the accompanying drawings, wherein:

FIG. 1A is a schematic illustration of a logistics facility incorporating aspects of the disclosed embodiment;

FIG. 1B is a schematic illustration of the logistics facility of FIG. 1A in accordance with aspects of the disclosed embodiment;

FIG. 2 is a schematic illustration of an autonomous guided vehicle, of the logistics facility of FIG. 1A, in accordance with aspects of the disclosed embodiment;

FIG. 3A is a schematic illustration of a portion of the autonomous guided vehicle of FIG. 2 in accordance with aspects of the disclosed embodiment;

FIG. 3B is a schematic illustration of a portion of the autonomous guided vehicle of FIG. 2 in accordance with aspects of the disclosed embodiment;

FIG. 3C is a schematic illustration of a portion of the autonomous guided vehicle of FIG. 2 in accordance with aspects of the disclosed embodiment;

FIGS. 4A, 4B and 4C are examples of image data captured with a vision system, of the autonomous guided vehicle of FIG. 2, in accordance with aspects of the disclosed embodiment;

FIG. 5 is a schematic illustration of a portion of the autonomous guided vehicle of FIG. 2 in accordance with aspects of the disclosed embodiment;

FIG. 6 is an exemplary illustration of a dense depth map generated from a pair of stereo images in accordance with aspects of the disclosed embodiment;

FIG. 7 is an exemplary illustration of stereo sets of keypoints in accordance with aspects of the disclosed embodiment;

FIG. 8 is an exemplary flow diagram for keypoint detection with respect to one image of a pair of stereo images in accordance with aspects of the disclosed embodiment;

FIG. 9 is an exemplary flow diagram for keypoint detection with respect a pair of stereo images in accordance with aspects of the disclosed embodiment;

FIG. 10 is an exemplary flow diagram for planar estimation of a face surface of an object in accordance with aspects of the disclosed embodiment;

FIG. 11 is a schematic illustration of stereo vision calibration stations, of the logistics facility of FIG. 1A, in accordance with aspects of the disclosed embodiment;

FIG. 12 is a schematic illustration of a portion of a calibration station of FIG. 11 in accordance with aspects of the disclosed embodiment;

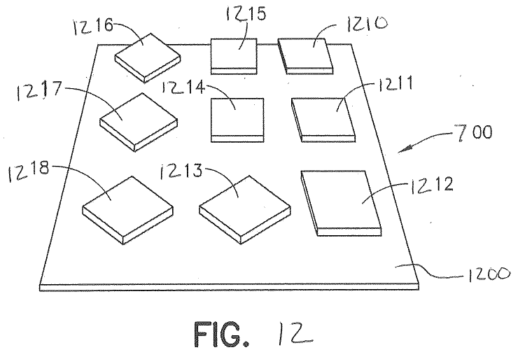

FIG. 13 is an exemplary schematic illustration of a model of the autonomous guided vehicle of FIG. 2 in accordance with aspects of the disclosed embodiment;

FIG. 14 is an exemplary flow diagram of a method in accordance with aspects of the disclosed embodiment; and

FIG. 15 is an exemplary flow diagram of a method in accordance with aspects of the disclosed embodiment.

### DETAILED DESCRIPTION

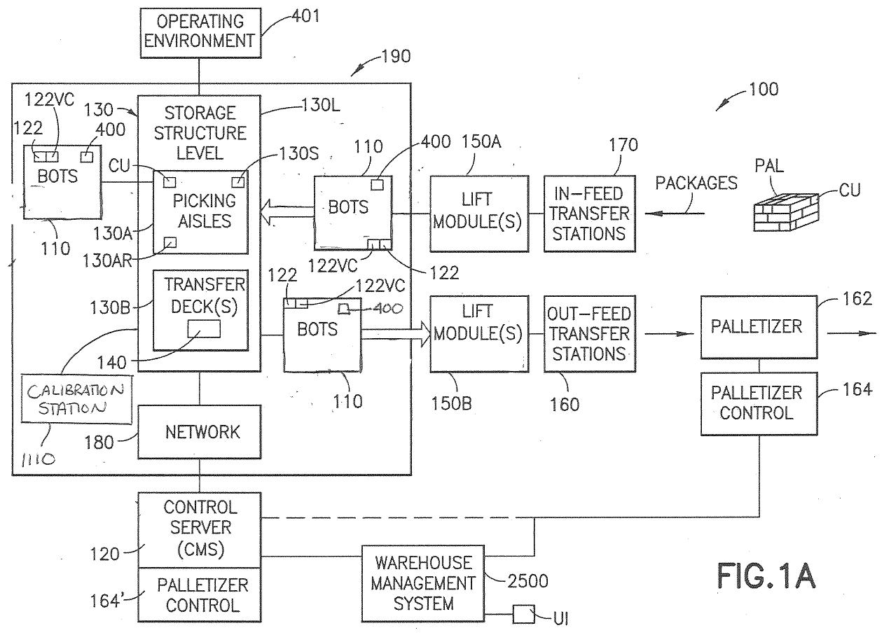

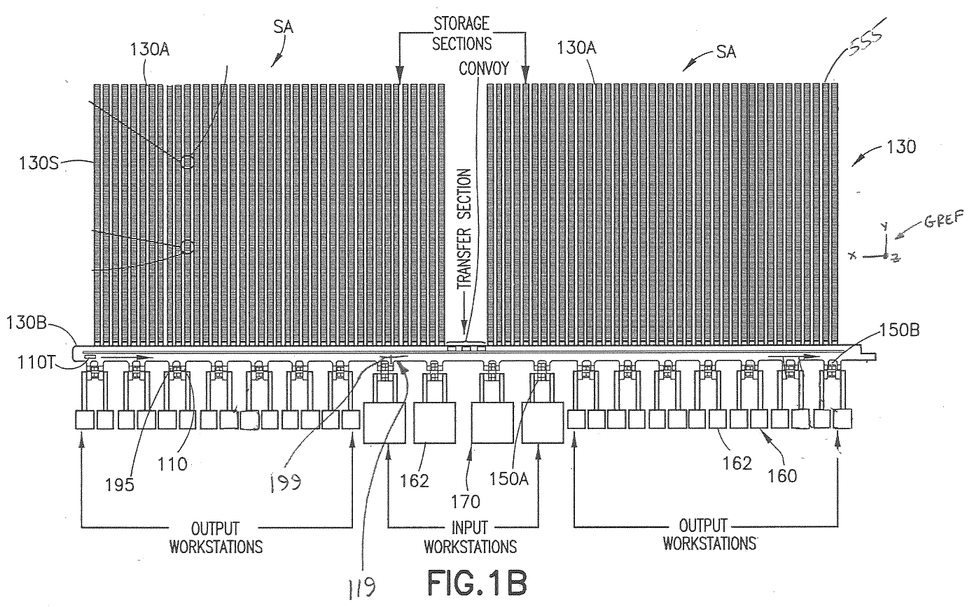

FIGS. 1A and 1B illustrate an exemplary automated storage and retrieval system 100 in accordance with aspects of the disclosed embodiment. Although the aspects of the disclosed embodiment will be described with reference to the drawings, it should be understood that the aspects of the disclosed embodiment could be embodied in many forms. In addition, any suitable size, shape or type of elements or materials could be used.

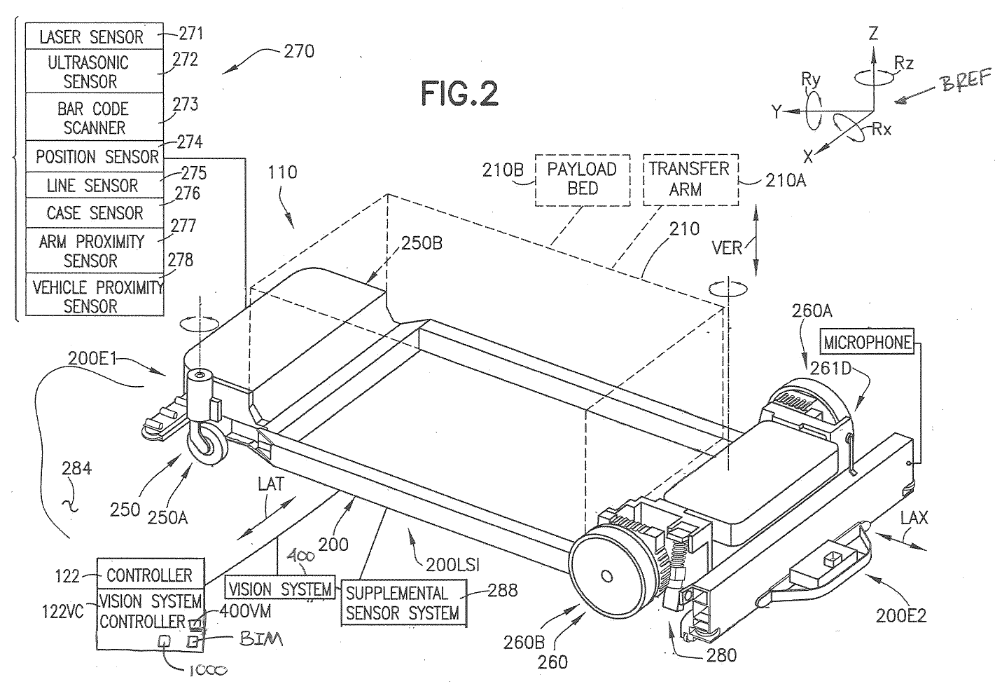

The aspects of the disclosed embodiment provide for a logistics autonomous guided vehicle 110 (referred to herein as an autonomous guided vehicle) having intelligent autonomy and collaborative operation. For example, the autonomous guided vehicle 110 includes a vision system 400 (see FIG. 2) having at least one (or more than one) camera 410A, 410B, 420A, 420B, 430A, 430B, 460A, 460B, 477A, 477B disposed to generate binocular or stereo images of a field commonly imaged by each camera of the at least one (or more than one) camera generating the binocular images (the binocular stereo images may be video stream data imaging or still image data) of a logistic space (such as the operating environment or space of the storage and retrieval system 100) that includes rack structure shelving 555 (see FIGS. 1B, 3A, and 4B) on which more than one objects (such as cases CU) are stored. The commonly imaged field is formed by a combination of individual fields 410AF, 410BF, 420AF, 420BF, 430AF, 430BF, 460AF, 460BF, 477AF, 477BF of a respective camera pair 410A and 410B, 420A and 420B, 430A and 430B, 460A and 460B, and/or 477A and 477B. For example, the commonly imaged field with respect to stereo image or binocular image cameras such as case unit monitoring cameras 410A, 410B (where “stereo image or binocular image cameras” are generally referred to herein as “stereo image cameras” which may be a camera pair or more than two cameras producing stereo images) is a combination of respective fields of view 410AF, 410BF. For exemplary purposes, the vision system 400 employs at least stereo or binocular vision that is configured to effect detection of cases CU and objects (such as facility structure and undesired foreign/transient materials) within a logistics facility, such as the automated storage and retrieval system 100. The stereo or binocular vision is also configured to effect autonomous guided vehicle localization within the automated storage and retrieval system 100. The vision system 400 also provides for collaborative vehicle operation by providing images (still or video stream, live or recorded) to an operator of the automated storage and retrieval system 100, where those images are, in some aspects, provided through a user interface UI as augmented images as described herein.

As will be described in greater detail herein, the autonomous guided vehicle 110 includes a controller 122 that is programmed to access data from the vision system 400 to effect robust case/object detection and localization of cases/objects within a super-constrained system or operating environment with at least one pair of inexpensive two-dimensional rolling shutter, unsynchronized cameras (although in other aspects the camera pairs may include comparatively more expensive two-dimensional global shutter cameras that may or may not be synchronized with one another) and with the autonomous guided vehicle 110 moving relative to the cases/objects. The super-constrained system includes, but is not limited to, at least the following constraints: spacing between dynamically positioned adjacent cases is a densely packed spacing (also referred to herein as closely packed juxtaposition with respect to each other), the autonomous guided vehicle is configured to underpick (lift from beneath) cases, different sized cases are distributed within the storage array SA in a Gaussian distribution, cases may exhibit deformities, and cases may be placed on a support surface in an irregular manner, all of which impact the transfer of case units CU between the storage shelf 555 (or other case holding location) and the autonomous guided vehicle 110.

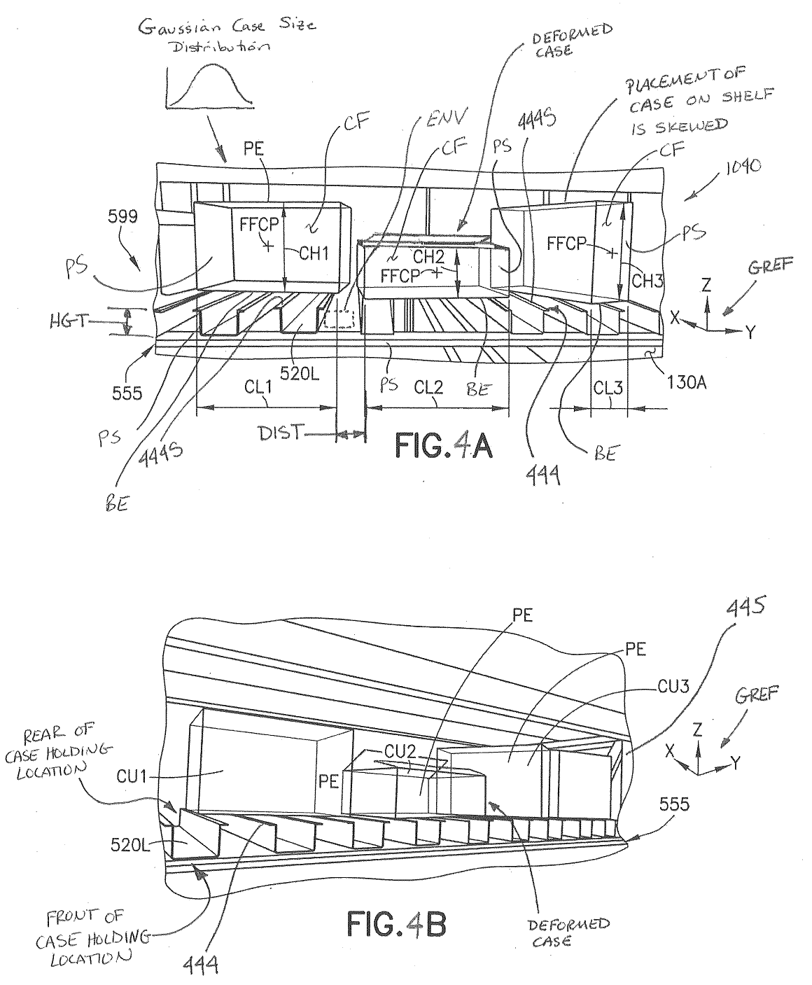

The cases CU stored in the storage and retrieval system have a Gaussian distribution (see FIG. 4A) with respect to the sizes of the cases within a picking aisle 130A and with respect to the sizes of cases throughout the storage array SA such that as cases are picked and placed, the size of any given storage space on a storage shelf 555 dynamically varies (e.g., a dynamic Gaussian case size distribution). As such, the autonomous guided vehicle 110 is configured, as described herein, to determine or otherwise identify cases held in the dynamically sized (according to the case held therein) storage spaces regardless of autonomous guided vehicle movement relative to the stored cases.

In addition, as can be seen in, e.g., FIG. 4A, the cases CU are placed on storage shelves 555 (or other holding station) in a close coupled or densely spaced relationship where the distance DIST between adjacent case units CU is about one-half the distance between storage shelf hats 444. The distance/width DIST between hats 444 of the support slats 520L is about 2.5 inches. The dense spacing of the cases CU may be compounded (i.e., the spacing may be less than one-half the distance between the storage shelf hats 444) in that the cases CU (e.g., deformed cases—see FIGS. 4A-4C illustrating an open flap case deformity) may exhibit deformations (e.g., such as bulging sides, open flaps, convex sides) and/or may be skewed relative to the hats 444 on which the cases CU sit (i.e., the front face of a case may not be parallel with the front of the storage shelf 555 and the lateral sides of the case may not be parallel with the hat 555 of the storage shelf 555—see FIG. 4A). The case deformities and the skewed case placement may further decrease the spacing between adjacent cases. As such, the autonomous guided vehicle is configured, as described herein, to determine or otherwise identify case pose and location, with the at least one pair of inexpensive two-dimensional rolling shutter, unsynchronized cameras, in the super-constrained system for transfer of the cases (e.g., picked from storage and placed to storage) substantially without interference between the densely spaced adjacent cases regardless of autonomous guided vehicle movement relative to the cases/objects.

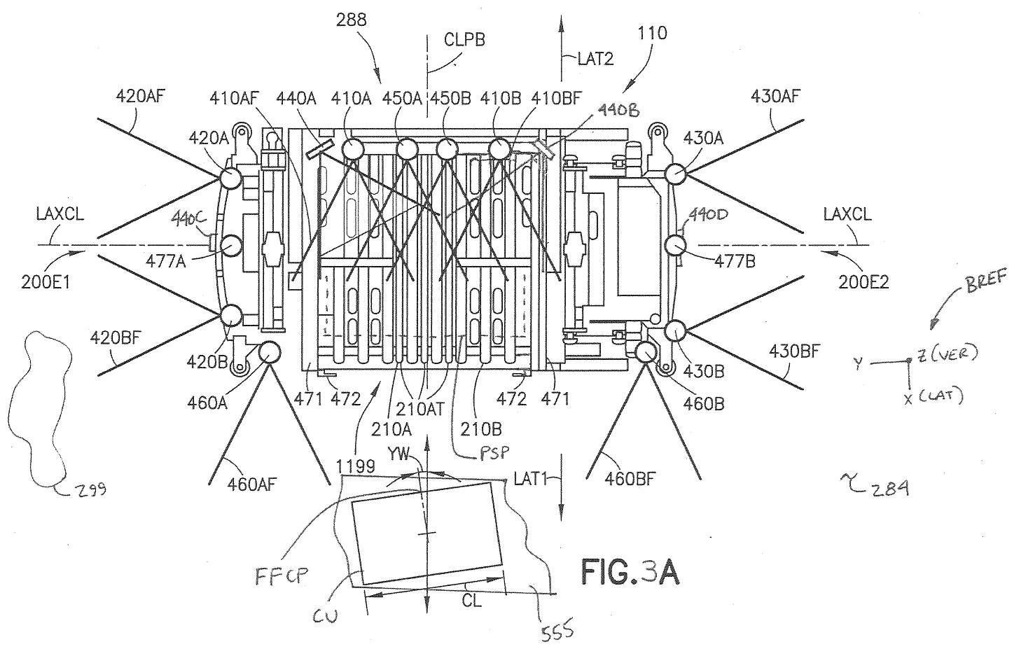

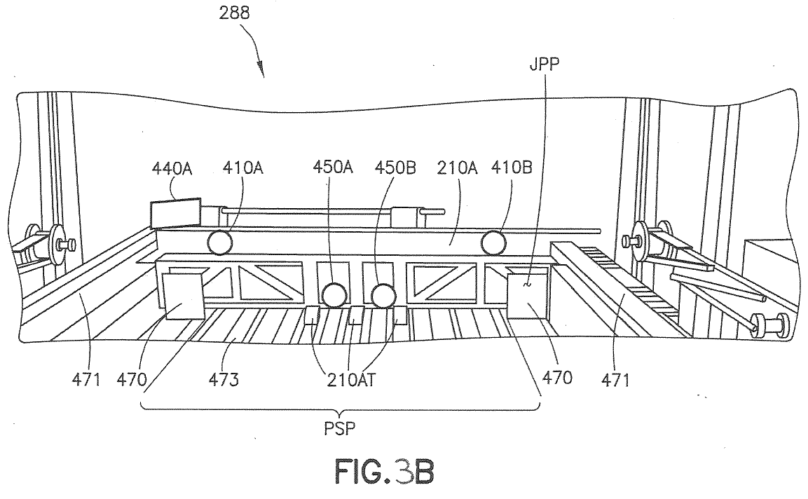

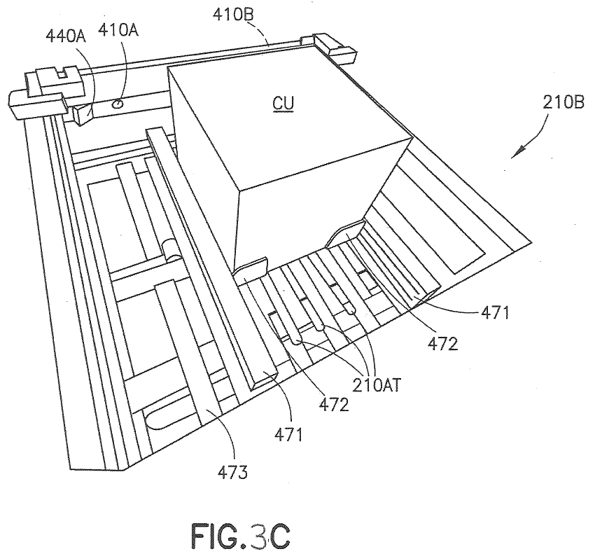

It is also noted that the height HGT of the hats 444 is about 2 inches, where a space envelope ENV between the hats 444 in which a tine 210AT of the transfer arm 210A of the autonomous guided vehicle 110 is inserted underneath a case unit CU for picking/placing cases to and from the storage shelf 555 is about 1.7 inches in width and about 1.2 inches in height (see, e.g., FIGS. 3A, 3C and 4A). The underpicking of the cases CU by the autonomous guided vehicle must interface with the cases CU, held on the storage shelf 555, at the pick/case support plane (defined by the case seating surfaces 444S of the hats 444—see FIG. 4A) without impact between the autonomous guided vehicle 110 transfer arm 210A tines 210AT and the hats 444/slats 520L, without impact between the tines 210AT and an adjacent case (that is not to be picked), and without impact between the case being picked and an adjacent case not being picked, all of which is effected with placement of the tines 210AT in the envelope ENV between the hats 444. As such, the autonomous guided vehicle is configured, as described herein, to detect and localize the space envelope ENV for inserting tines 210AT of a transfer arm 210A beneath a predetermined case CU, for picking the case with the at least one pair of inexpensive two-dimensional rolling shutter, unsynchronized cameras described herein.

Another constraint of the super-constrained system is the transfer time for an autonomous guided vehicle 110 to transfer a case unit(s) between a payload bed 210B of the autonomous guided vehicle 110 and a case holding location (e.g., storage space, buffer, transfer station, or other case holding location described herein). Here, the transfer time for case transfer is about 10 seconds or less. As such, the vision system 400 discriminates case location and pose (or holding station location and pose) in less than about two seconds or in less than about half a second.

The super-constrained system described above requires robustness of the vision system, and may be considered to define the robustness of the vision system 400 as the vision system 400 is configured to accommodate the above-noted constraints and may provide pose and localization information for cases CU and/or the autonomous guided vehicle 110 that effects an autonomous guided vehicle pick failure rate of about one pick failure for every about one million picks.

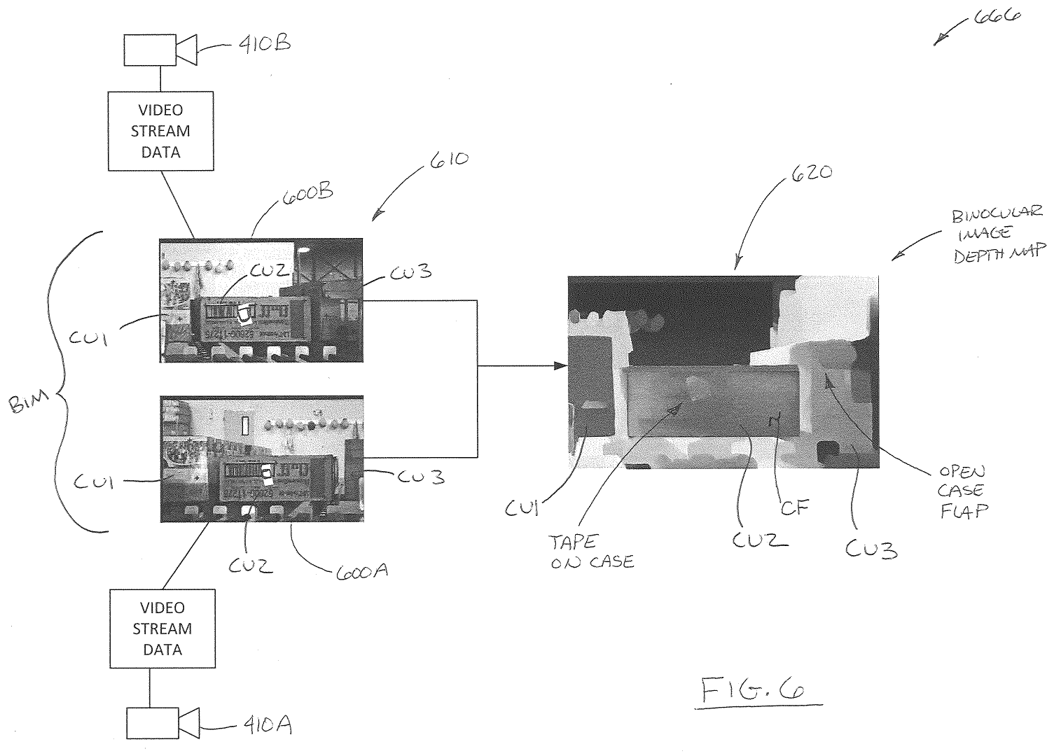

In accordance with the aspects of the disclosed embodiment, the autonomous guided vehicle 110 includes a controller (e.g., controller 122 or vision system controller 122VC that is communicably coupled to or otherwise forms a part of controller 122) that registers image data (e.g., video stream) from the cameras in one or more pairs of cameras (e.g., the pairs of cameras being formed by respective ones of the cameras 410A, 410B, 420A, 420B, 430A, 430B, 460A, 460B, 477A, 477B). The controller is configured to parse the registered (video) image data into individual registered (still) image frames to form a set of still (as opposed to the motion video from which the images are parsed) stereo vision image frames (e.g., see image frames 600A, 600B in FIG. 6 as an example) for the respective camera pair (such as camera pair 410A, 410B illustrated in, e.g., FIG. 3A).

As will be described herein, the controller generates a dense depth map of objects within the fields of view of the cameras, in the pair of cameras, from the stereo vision frames so as to discriminate location and pose of imaged objects from the dense depth map. The controller also generates binocular keypoint data for the stereo vision frames, the keypoint data being separate and distinct from the dense depth map, where the keypoint data effects (e.g., binocular, three-dimensional) discrimination of location and pose of the objects within the fields of view of the cameras. It is noted that while the term “keypoint” is used herein, the keypoints described herein are also referred to in the art as “feature point(s),” “invariant feature(s),” “invariant point(s),” or a “characteristic” (such as a corner or facet joint or object surface). The controller combines the dense depth map with the keypoint data, with a weighted emphasis on the keypoint data, to determine or otherwise identify the pose and location of the imaged objects (e.g., in the logistics space and/or relative to the autonomous guided vehicle 110) with an accuracy that is greater than a pose and location determination accuracy of the dense depth map alone and greater than a pose and location determination accuracy of the keypoint data alone.

In accordance with the aspects of the disclosed embodiment, the automated storage and retrieval system 100 in FIGS. 1A and 1B may be disposed in a retail distribution (logistics) center or warehouse, for example, to fulfill orders received from retail stores for replenishment goods shipped in cases, packages, and or parcels. The terms case, package and parcel are used interchangeably herein and as noted before may be any container that may be used for shipping and may be filled with one or more product units by the producer. Case or cases as used herein means case, package or parcel units not stored in trays, on totes, etc. (e.g., uncontained). It is noted that the case units CU (also referred to herein as mixed cases, cases, and shipping units) may include cases of items/units (e.g., case of soup cans, boxes of cereal, etc.) or an individual item/unit that are adapted to be taken off of or placed on a pallet. In accordance with the exemplary embodiments, shipping cases or case units (e.g., cartons, barrels, boxes, crates, jugs, shrink wrapped trays or groups or any other suitable device for holding case units) may have variable sizes and may be used to hold case units in shipping and may be configured so they are capable of being palletized for shipping. Case units may also include totes, boxes, and/or containers of one or more individual goods, unpacked/decommissioned (generally referred to as breakpack goods) from original packaging and placed into the tote, boxes, and/or containers (collectively referred to as totes) with one or more other individual goods of mixed or common types at an order fill station. It is noted that when, for example, incoming bundles or pallets (e.g., from manufacturers or suppliers of case units arrive at the storage and retrieval system for replenishment of the automated storage and retrieval system 100, the content of each pallet may be uniform (e.g. each pallet holds a predetermined number of the same item—one pallet holds soup and another pallet holds cereal). As may be realized, the cases of such pallet load may be substantially similar or in other words, homogenous cases (e.g. similar dimensions), and may have the same SKU (otherwise, as noted before the pallets may be “rainbow” pallets having layers formed of homogeneous cases). As pallets leave the storage and retrieval system, with cases or totes filling replenishment orders, the pallets may contain any suitable number and combination of different case units (e.g., each pallet may hold different types of case units—a pallet holds a combination of canned soup, cereal, beverage packs, cosmetics and household cleaners). The cases combined onto a single pallet may have different dimensions and/or different SKU's.

The automated storage and retrieval system 100 may be generally described as a storage and retrieval engine 190 coupled to a palletizer 162. In greater detail now, and with reference still to FIGS. 1A and 1B, the storage and retrieval system 100 may be configured for installation in, for example, existing warehouse structures or adapted to new warehouse structures. As noted before the automated storage and retrieval system 100 shown in FIGS. 1A and 1B is representative and may include for example, in-feed and out-feed conveyors terminating on respective transfer stations 170, 160, lift module(s) 150A, 150B, a storage structure 130, and a number of autonomous guided vehicles 110. It is noted that the storage and retrieval engine 190 is formed at least by the storage structure 130 and the autonomous guided vehicles 110 (and in some aspect the lift modules 150A, 150B; however in other aspects the lift modules 150A, 150B may form vertical sequencers in addition to the storage and retrieval engine 190 as described in U.S. patent application Ser. No. 17/091,265 filed on Nov. 6, 2020 and titled “Pallet Building System with Flexible Sequencing,” the disclosure of which is incorporated herein by reference in its entirety). In alternate aspects, the storage and retrieval system 100 may also include robot or bot transfer stations (not shown) that may provide an interface between the autonomous guided vehicles 110 and the lift module(s) 150A, 150B. The storage structure 130 may include multiple levels of storage rack modules where each storage structure level 130L of the storage structure 130 includes respective picking aisles 130A, and transfer decks 130B for transferring case units between any of the storage areas of the storage structure 130 and a shelf of the lift module(s) 150A, 150B. The picking aisles 130A are in one aspect configured to provide guided travel of the autonomous guided vehicles 110 (such as along rails 130AR) while in other aspects the picking aisles are configured to provide unrestrained travel of the autonomous guided vehicle 110 (e.g., the picking aisles are open and undeterministic with respect to autonomous guided vehicle 110 guidance/travel). The transfer decks 130B have open and undeterministic bot support travel surfaces along which the autonomous guided vehicles 110 travel under guidance and control provided by any suitable bot steering. In one or more aspects, the transfer decks 130B have multiple lanes between which the autonomous guided vehicles 110 freely transition for accessing the picking aisles 130A and/or lift modules 150A, 150B. As used herein, “open and undeterministic” denotes the travel surface of the picking aisle and/or the transfer deck has no mechanical restraints (such as guide rails) that delimit the travel of the autonomous guided vehicle 110 to any given path along the travel surface.

The picking aisles 130A, and transfer decks 130B also allow the autonomous guided vehicles 110 to place case units CU into picking stock and to retrieve ordered case units CU (and define the different positions where the bot performs autonomous tasks, though any number of locations in the storage structure (e.g., decks, aisles, storage racks, etc.) can be one or more of the different positions). In alternate aspects, each level may also include respective transfer stations 140 that provide for an indirect case transfer between the autonomous guided vehicles 110 and the lift modules 150A, 150B. The autonomous guided vehicles 110 may be configured to place case units, such as the above described retail merchandise, into picking stock in the one or more storage structure levels 130L of the storage structure 130 and then selectively retrieve ordered case units for shipping the ordered case units to, for example, a store or other suitable location. The in-feed transfer stations 170 and out-feed transfer stations 160 may operate together with their respective lift module(s) 150A, 150B for bi-directionally transferring case units CU to and from one or more storage structure levels 130L of the storage structure 130. It is noted that while the lift modules 150A, 150B may be described as being dedicated inbound lift modules 150A and outbound lift modules 150B, in alternate aspects each of the lift modules 150A, 150B may be used for both inbound and outbound transfer of case units from the storage and retrieval system 100.

As may be realized, the storage and retrieval system 100 may include multiple in-feed and out-feed lift modules 150A, 150B that are accessible (e.g., indirectly through transfer stations 140 or through transfer of cases directly between the lift module 150A, 150B and the autonomous guided vehicle 110) by, for example, autonomous guided vehicles 110 of the storage and retrieval system 100 so that one or more case unit(s), uncontained (e.g., case unit(s) are not held in trays), or contained (within a tray or tote) can be transferred from a lift module 150A, 150B to each storage space on a respective level and from each storage space to any one of the lift modules 150A, 150B on a respective level. The autonomous guided vehicles 110 may be configured to transfer the cases CU (also referred to herein as case units) between the storage spaces 130S (e.g., located in the picking aisles 130A or other suitable storage space/case unit buffer disposed along the transfer deck 130B) and the lift modules 150A, 150B. Generally, the lift modules 150A, 150B include at least one movable payload support that may move the case unit(s) between the in-feed and out-feed transfer stations 160, 170 and the respective level of the storage space where the case unit(s) is stored and retrieved. The lift module(s) may have any suitable configuration, such as for example reciprocating lift, or any other suitable configuration. The lift module(s) 150A, 150B include any suitable controller (such as control server 120 or other suitable controller coupled to control server 120, warehouse management system 2500, and/or palletizer controller 164, 164′) and may form a sequencer or sorter in a manner similar to that described in U.S. patent application Ser. No. 16/444,592 filed on Jun. 18, 2019 and titled “Vertical Sequencer for Product Order Fulfillment” (the disclosure of which is incorporated herein by reference in its entirety).

The automated storage and retrieval system 100 may include a control system, comprising for example one or more control servers 120 that are communicably connected to the in-feed and out-feed conveyors and transfer stations 170, 160, the lift modules 150A, 150B, and the autonomous guided vehicles 110 via a suitable communication and control network 180. The communication and control network 180 may have any suitable architecture which, for example, may incorporate various programmable logic controllers (PLC) such as for commanding the operations of the in-feed and out-feed conveyors and transfer stations 170, 160, the lift modules 150A, 150B, and other suitable system automation. The control server 120 may include high level programming that effects a case management system (CMS) managing the case flow system. The network 180 may further include suitable communication for effecting a bi-directional interface with the autonomous guided vehicles 110. For example, the autonomous guided vehicles 110 may include an on-board processor/controller 122. The network 180 may include a suitable bi-directional communication suite enabling the autonomous guided vehicle controller 122 to request or receive commands from the control server 120 for effecting desired transport (e.g. placing into storage locations or retrieving from storage locations) of case units and to send desired autonomous guided vehicle 110 information and data including autonomous guided vehicle 110 ephemeris, status and other desired data, to the control server 120. As seen in FIGS. 1A and 1B, the control server 120 may be further connected to a warehouse management system 2500 for providing, for example, inventory management, and customer order fulfillment information to the CMS level program of control server 120. As noted before, the control server 120, and/or the warehouse management system 2500 allow for a degree of collaborative control, at least of autonomous guided vehicles 110, via a user interface UI, as will be further described below. A suitable example of an automated storage and retrieval system arranged for holding and storing case units is described in U.S. Pat. No. 9,096,375, issued on Aug. 4, 2015 the disclosure of which is incorporated by reference herein in its entirety.

Referring now to FIGS. 1A, 1B, and 2, the autonomous guided vehicle 110 includes a frame 200 with an integral payload support or bed 210B (also referred to as a payload hold or payload bay). The frame 200 has a front end 200E1 and a back end 200E2 that define a longitudinal axis LAX of the autonomous guided vehicle 110. The frame 200 may be constructed of any suitable material (e.g., steel, aluminum, composites, etc.) and includes a case handling assembly 210 configured to handle cases/payloads transported by the autonomous guided vehicle 110. The case handling assembly 210 includes the payload bed 210B on which payloads are placed for transport and/or any suitable transfer arm 210A (also referred to as a payload handler) connected to the frame. The transfer arm 210A is configured to (autonomously) transfer a payload (such as a case unit CU), with a flat undeterministic seating surface seated in the payload bed 210B, to and from the payload bed 210B of the autonomous guided vehicle 110 and a storage location (such as storage space 130S on a storage shelf 555 (see FIG. 2), a shelf of lift module 150A, 150B, buffer, transfer station, and/or any other suitable storage location), of the payload CU, in a storage array SA, where the storage location 130S, in the storage array SA, is separate and distinct from the transfer arm 210A and the payload bed 210B. The transfer arm 210A is configured to extend laterally in direction LAT and/or vertically in direction VER to transport payloads to and from the payload bed 210B. Examples of suitable payload beds 210B and transfer arms 210A and/or autonomous guided vehicles 110 to which the aspects of the disclosed embodiment may be applied can be found in U.S. patent Ser. No. 11/078,017 issued on Aug. 3, 2021 and titled “Automated Bot with Transfer Arm”; U.S. Pat. No. 7,591,630 issued on Sep. 22, 2009 titled “Materials-Handling System Using Autonomous Transfer and Transport Vehicles”; U.S. Pat. No. 7,991,505 issued on Aug. 2, 2011 titled “Materials-Handling System Using Autonomous Transfer and Transport Vehicles”; U.S. Pat. No. 9,561,905 issued on Feb. 7, 2017 titled “Autonomous Transport Vehicle”; U.S. Pat. No. 9,082,112 issued on Jul. 14, 2015 titled “Autonomous Transport Vehicle Charging System”; U.S. Pat. No. 9,850,079 issued on Dec. 26, 2017 titled “Storage and Retrieval System Transport Vehicle”; U.S. Pat. No. 9,187,244 issued on Nov. 17, 2015 titled “Bot Payload Alignment and Sensing”; U.S. Pat. No. 9,499,338 issued on Nov. 22, 2016 titled “Automated Bot Transfer Arm Drive System”; U.S. Pat. No. 8,965,619 issued on Feb. 24, 2015 titled “Bot Having High Speed Stability”; U.S. Pat. No. 9,008,884 issued on Apr. 14, 2015 titled “Bot Position Sensing”; U.S. Pat. No. 8,425,173 issued on Apr. 23, 2013 titled “Autonomous Transports for Storage and Retrieval Systems”; and U.S. Pat. No. 8,696,010 issued on Apr. 15, 2014 titled “Suspension System for Autonomous Transports”, the disclosures of which are incorporated herein by reference in their entireties.

The frame 200 includes one or more idler wheels or casters 250 disposed adjacent the front end 200E1. Suitable examples of casters can be found in U.S. patent application Ser. No. 17/664,948 titled “Autonomous Transport Vehicle with Synergistic Vehicle Dynamic Response” (having attorney docket number 1127P015753-US (PAR)) filed on May 25, 2022 ( ) and U.S. patent application Ser. No. 17/664,838 titled “Autonomous Transport Vehicle with Steering” (having attorney docket number 1127P015753-US (PAR)) filed on May 26, 2021, the disclosures of which are incorporated herein by reference in their entireties. The frame 200 also includes one or more drive wheels 260 disposed adjacent the back end 200E2. In other aspects, the position of the casters 250 and drive wheels 260 may be reversed (e.g., the drive wheels 260 are disposed at the front end 200E1 and the casters 250 are disposed at the back end 200E2). It is noted that in some aspects, the autonomous guided vehicle 110 is configured to travel with the front end 200E1 leading the direction of travel or with the back end 200E2 leading the direction of travel. In one aspect, casters 250A, 250B (which are substantially similar to caster 250 described herein) are located at respective front corners of the frame 200 at the front end 200E1 and drive wheels 260A, 260B (which are substantially similar to drive wheel 260 described herein) are located at respective back corners of the frame 200 at the back end 200E2 (e.g., a support wheel is located at each of the four corners of the frame 200) so that the autonomous guided vehicle 110 stably traverses the transfer deck(s) 130B and picking aisles 130A of the storage structure 130.

The autonomous guided vehicle 110 includes a drive section 261D, connected to the frame 200, with drive wheels 260 supporting the autonomous guided vehicle 110 on a traverse/rolling surface 284, where the drive wheels 260 effect vehicle traverse on the traverse surface 284 moving the autonomous guided vehicle 110 over the traverse surface 284 in a facility (e.g., such as a warehouse, store, etc.). The drive section 261D has at least a pair of traction drive wheels 260 (also referred to as drive wheels 260—see drive wheels 260A, 260B) astride the drive section 261D. The drive wheels 260 have a fully independent suspension 280 coupling each drive wheel 260A, 260B of the at least pair of drive wheels 260 to the frame 200 and configured to maintain a substantially steady state traction contact patch between the at least one drive wheel 260A, 260B and rolling/travel surface 284 (also referred to as autonomous vehicle travel surface 284) over rolling surface transients (e.g., bumps, surface transitions, etc.) Suitable examples of the fully independent suspension 280 can be found in U.S. patent application Ser. No. 17/664,948 titled “Autonomous Transport Vehicle with Synergistic Vehicle Dynamic Response” (having attorney docket number 1127P015753-US (PAR)) filed on May 25, 2022, the disclosure of which was previously incorporated herein by reference in its entirety.

The autonomous guided vehicle 110 includes a physical characteristic sensor system 270 (also referred to as an autonomous navigation operation sensor system) connected to the frame 200. The physical characteristic sensor system 270 has electro-magnetic sensors. Each of the electro-magnetic sensors is responsive to interaction or interface of a sensor emitted or generated electro-magnetic beam or field with a physical characteristic (e.g., of the storage structure or a transient object such as a case unit CU, debris, etc.), where the electro-magnetic beam or field is disturbed by interaction or interface with the physical characteristic. The disturbance in the electro-magnetic beam is detected by and effects sensing by the electro-magnetic sensor of the physical characteristic, wherein the physical characteristic sensor system 270 is configured to generate sensor data embodying at least one of a vehicle navigation pose or location (relative to the storage and retrieval system or facility in which the autonomous guided vehicle 110 operates) information and payload pose or location (relative to a storage location 130S or the payload bed 210B) information.

The physical characteristic sensor system 270 includes, for exemplary purposes only, one or more of laser sensor(s) 271, ultrasonic sensor(s) 272, bar code scanner(s) 273, position sensor(s) 274, line sensor(s) 275, case sensors 278 (e.g., for sensing case units within the payload bed 210B onboard the vehicle 110 or on a storage shelf off-board the vehicle 110), arm proximity sensor(s) 277, vehicle proximity sensor(s) 278 or any other suitable sensors for sensing a position of the vehicle 110 or a payload (e.g., case unit CU). In some aspects, supplemental navigation sensor system 288 may form a portion of the physical characteristic sensor system 270. Suitable examples of sensors that may be included in the physical characteristic sensor system 270 are described in U.S. Pat. No. 8,425,173 titled “Autonomous Transport for Storage and Retrieval Systems” issued on Apr. 23, 2013, U.S. Pat. No. 9,008,884 titled “Bot Position Sensing” issued on Apr. 14, 2015, and U.S. Pat. No. 9,946,265 titled Bot Having High Speed Stability” issued on Apr. 17, 2018, the disclosures of which are incorporated herein by reference in their entireties.

The sensors of the physical characteristic sensor system 270 may be configured to provide the autonomous guided vehicle 110 with, for example, awareness of its environment and external objects, as well as the monitor and control of internal subsystems. For example, the sensors may provide guidance information, payload information or any other suitable information for use in operation of the autonomous guided vehicle 110.

The bar code scanner(s) 273 may be mounted on the autonomous guided vehicle 110 in any suitable location. The bar code scanners(s) 273 may be configured to provide an absolute location of the autonomous guided vehicle 110 within the storage structure 130. The bar code scanner(s) 273 may be configured to verify aisle references and locations on the transfer decks by, for example, reading bar codes located on, for example the transfer decks, picking aisles and transfer station floors to verify a location of the autonomous guided vehicle 110. The bar code scanner(s) 273 may also be configured to read bar codes located on items stored in the shelves 555.

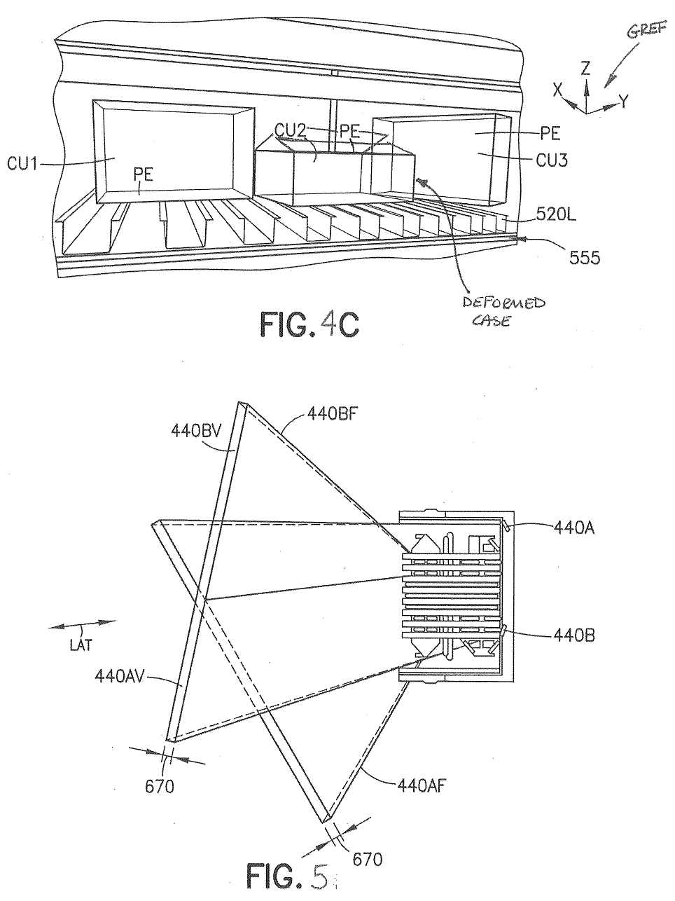

The position sensors 274 may be mounted to the autonomous guided vehicle 110 at any suitable location. The position sensors 274 may be configured to detect reference datum features (or count the slats 520L of the storage shelves 555) (e.g. see FIG. 5A) for determining a location of the vehicle 110 with respect to the shelving of, for example, the picking aisles 130A (or a buffer/transfer station located adjacent the transfer deck 130B or lift 150). The reference datum information may be used by the controller 122 to, for example, correct the vehicle's odometry and allow the autonomous guided vehicle 110 to stop with the support tines 210AT of the transfer arm 210A positioned for insertion into the spaces between the slats 520L (see, e.g., FIG. 5A). In one exemplary embodiment, the vehicle 110 may include position sensors 274 on the drive (rear) end 200E2 and the driven (front) end 200E1 of the autonomous guided vehicle 110 to allow for reference datum detection regardless of which end of the autonomous guided vehicle 110 is facing the direction the autonomous guided vehicle 110 is travelling.

The line sensors 275 may be any suitable sensors mounted to the autonomous guided vehicle 110 in any suitable location, such as for exemplary purposes only, on the frame 200 disposed adjacent the drive (rear) and driven (front) ends 200E2, 200E1 of the autonomous guided vehicle 110. For exemplary purposes only, the line sensors 275 may be diffuse infrared sensors. The line sensors 275 may be configured to detect guidance lines 199 (see FIG. 1B) provided on, for example, the floor of the transfer decks 130B. The autonomous guided vehicle 110 may be configured to follow the guidance lines when travelling on the transfer decks 130B and defining ends of turns when the vehicle is transitioning on or off the transfer decks 130B. The line sensors 275 may also allow the vehicle 110 to detect index references for determining absolute localization where the index references are generated by crossed guidance lines 119 (see FIG. 1B).

The case sensors 276 may include case overhang sensors and/or other suitable sensors configured to detect the location/pose of a case unit CU within the payload bed 210B. The case sensors 276 may be any suitable sensors that are positioned on the vehicle so that the sensor(s) field of view(s) span the payload bed 210B adjacent the top surface of the support tines 210AT (see FIGS. 3A and 3B). The case sensors 276 may be disposed at the edge of the payload bed 210B (e.g., adjacent a transport opening 1199 of the payload bed 210B to detect any case units CU that are at least partially extending outside of the payload bed 210B.

The arm proximity sensors 277 may be mounted to the autonomous guided vehicle 110 in any suitable location, such as for example, on the transfer arm 210A. The arm proximity sensors 277 may be configured to sense objects around the transfer arm 210A and/or support tines 210AT of the transfer arm 210A as the transfer arm 210A is raised/lowered and/or as the support tines 210AT are extended/retracted.

The laser sensors 271 and ultrasonic sensors 272 may be configured to allow the autonomous guided vehicle 110 to locate itself relative to each case unit forming the load carried by the autonomous guided vehicle 110 before the case units are picked from, for example, the storage shelves 555 and/or lift 150 (or any other location suitable for retrieving payload). The laser sensors 271 and ultrasonic sensors 272 may also allow the vehicle to locate itself relative to empty storage locations 130S for placing case units in those empty storage locations 130S. The laser sensors 271 and ultrasonic sensors 272 may also allow the autonomous guided vehicle 110 to confirm that a storage space (or other load depositing location) is empty before the payload carried by the autonomous guided vehicle 110 is deposited in, for example, the storage space 130S. In one example, the laser sensor 271 may be mounted to the autonomous guided vehicle 110 at a suitable location for detecting edges of items to be transferred to (or from) the autonomous guided vehicle 110. The laser sensor 271 may work in conjunction with, for example, retro-reflective tape (or other suitable reflective surface, coating or material) located at, for example, the back of the shelves 555 to enable the sensor to “see” all the way to the back of the storage shelves 555. The reflective tape located at the back of the storage shelves allows the laser sensor 1715 to be substantially unaffected by the color, reflectiveness, roundness, or other suitable characteristics of the items located on the shelves 555. The ultrasonic sensor 272 may be configured to measure a distance from the autonomous guided vehicle 110 to the first item in a predetermined storage area of the shelves 555 to allow the autonomous guided vehicle 110 to determine the picking depth (e.g. the distance the support tines 210AT travel into the shelves 555 for picking the item(s) off of the shelves 555). One or more of the laser sensors 271 and ultrasonic sensors 272 may allow for detection of case orientation (e.g. skewing of cases within the storage shelves 555) by, for example, measuring the distance between the autonomous guided vehicle 110 and a front surface of the case units to be picked as the autonomous guided vehicle 110 comes to a stop adjacent the case units to be picked. The case sensors may allow verification of placement of a case unit on, for example, a storage shelf 555 by, for example, scanning the case unit after it is placed on the shelf.

Vehicle proximity sensors 278 may also be disposed on the frame 200 for determining the location of the autonomous guided vehicle 110 in the picking aisle 130A and/or relative to lifts 150. The vehicle proximity sensors 278 are located on the autonomous guided vehicle 110 so as to sense targets or position determining features disposed on rails 130AR on which the vehicle 110 travels through the picking aisles 130A (and/or on walls of transfer areas 195 and/or lift 150 access location). The position of the targets on the rails 130AR are in known locations so as to form incremental or absolute encoders along the rails 130AR. The vehicle proximity sensors 278 sense the targets and provide sensor data to the controller 122 so that the controller 122 determines the position of the autonomous guided vehicle 110 along the picking aisle 130A based on the sensed targets.

The sensors of the physical characteristic sensing system 270 are communicably coupled to the controller 122 of the autonomous guided vehicle 110. As described herein, the controller 122 is operably connected to the drive section 261D and/or the transfer arm 210A. The controller 122 is configured to determine from the information of the physical characteristic sensor system 270 vehicle pose and location (e.g., in up to six degrees of freedom, X, Y, Z, Rx, Ry, Rz) effecting independent guidance of the autonomous guided vehicle 110 traversing the storage and retrieval facility/system 100. The controller 122 is also configured to determine from the information of the physical characteristic sensor system 270 payload (e.g., case unit CU) pose and location (onboard or off-board the autonomous guided vehicle 110) effecting independent underpick (e.g., lifting of the case unit CU from underneath the case unit CU) and place of the payload CU to and from a storage location 130S and independent underpick and place of the payload CU in the payload bed 210B.

Referring to FIGS. 1A, 1B, 2, 3A, and 3B, as described above, the autonomous guided vehicle 110 includes a supplemental or auxiliary navigation sensor system 288, connected to the frame 200. The supplemental navigation sensor system 288 supplements the physical characteristic sensor system 270. The supplemental navigation sensor system 288 is, at least in part, a vision system 400 with cameras disposed to capture image data informing at least one of a vehicle navigation pose or location (relative to the storage and retrieval system structure or facility in which the vehicle 110 operates) and payload pose or location (relative to the storage locations or payload bed 210B) that supplements the information of the physical characteristic sensor system 270. It is noted that the term “camera” described herein is a still imaging and/or video imaging device that includes one or more of a two-dimensional camera and a two-dimensional camera with RGB (red, green, blue) pixels, non-limiting examples of which are provided herein. For example, as described herein, the two-dimensional cameras (with or without RGB pixels) are inexpensive (e.g., compared to a global shutter camera) two-dimensional rolling shutter, unsynchronized cameras (although in other aspects the cameras may be global shutter cameras that may or may not be synchronized with one another). In other aspects, the two-dimensional rolling shutter cameras in, e.g., a pair of cameras may be synchronized with each other. Non-limiting examples of the two-dimensional cameras include commercially available (i.e., “off the shelf”) USB cameras each having 0.3 Megapixels and a resolution of 640×480, MIPI Camera Serial Interface 2 (MIPI CSI-2®) cameras each having 8 Megapixels and a resolution of 1280×720, or any other suitable cameras.

Referring to FIGS. 2, 3A, and 3B, the vision system 400 includes one or more of the following: case unit monitoring cameras 410A, 410B, forward navigation cameras 420A, 420B, rearward navigation cameras 430A, 430B, one or more three-dimensional imaging system 440A, 440B, one or more case edge detection sensors 450A, 450B, one or more traffic monitoring camera 460A, 460B, and one or more out of plane (e.g., upward or downward facing) localization cameras 477A, 477B (noting the downward facing cameras may supplement the line following sensors 275 of the physical characteristic sensor system 270 and provide a broader field of view than the line following sensors 275 so as to effect guidance/traverse of the vehicle 110 to place the guide lines 199 (see FIG. 1B) back within the field of view of the line following sensors 275 in the event the vehicle path strays from the guide line 199 removing the guide line 199 from the line following sensor 275 field of view). Images (static images and/or dynamic video images) from the different vision system 400 cameras are requested from the vision system controller 122VC by the controller 122 as desired for any given autonomous guided vehicle 110 task. For example, images are obtained by the controller 122 from at least one or more of the forward and rearward navigation cameras 420A, 420B, 430A, 430B to effect navigation of the autonomous guided vehicle 110 along the transfer deck 130B and picking aisles 130A.

The forward navigation cameras 420A, 420B may be paired to form a stereo camera system and the rearward navigation cameras 430A, 430B may be paired to form another stereo camera system. Referring to FIGS. 2 and 3A, the forward navigation cameras 420A, 420B, are any suitable cameras (such as those described above) configured to provide object detection and ranging in the manner described herein. The forward navigation cameras 420A, 420B may be placed on opposite sides of the longitudinal centerline LAXCL of the autonomous transport vehicle 110 and spaced apart by any suitable distance so that the forward facing fields of view 420AF, 420BF provide the autonomous transport vehicle 110 with stereo vision. The forward navigation cameras 420A, 420B are any suitable high resolution or low resolution video cameras (such as those described herein, where video images that include more than about 480 vertical scan lines and are captured at more than about 50 frames/second are considered high resolution), or any other suitable cameras configured to provide object detection and ranging as described herein for effecting autonomous vehicle traverse along the transfer deck 130B and picking aisles 130A. The rearward navigation cameras 430A, 430B may be substantially similar to the forward navigation cameras. The forward navigation cameras 420A, 420B and the rear navigation cameras 430A, 430B provide for autonomous guided vehicle 110 navigation with obstacle detection and avoidance (with either end 200E1 of the autonomous guided vehicle 110 leading a direction of travel or trailing the direction of travel) as well as localization of the autonomous transport vehicle within the storage and retrieval system 100. Localization of the autonomous guided vehicle 110 may be effected by one or more of the forward navigation cameras 420A, 420B and the rearward navigation cameras 430A, 430B by detection of guide lines on the travel/rolling surface 284 and/or by detection of suitable storage structure, including but not limited to storage rack (or other) structure. The line detection and/or storage structure detection may be compared to floor maps and structure information (e.g., stored in a memory of or accessible by) of the vision system controller 122VC. The forward navigation cameras 420A, 420B and the rearward navigation cameras 430A, 430B may also send signal to the controller 122 (inclusive of or through the vision system controller 122VC) so that as objects approach the autonomous transport vehicle 110 (with the autonomous transport vehicle 110 stopped or in motion) the autonomous transport vehicle 110 may be maneuvered (e.g., on the undeterministic rolling surface of the transfer deck 130B or within the picking aisle 130A (which may have a deterministic or undeterministic rolling surface) to avoid the approaching object (e.g., another autonomous transport vehicle, case unit, or other transient object within the storage and retrieval system 100).

The forward navigation cameras 420A, 420B and the rear navigation cameras 430A, 430B may also provide for convoys of vehicles 110 along the picking aisles 130A or transfer deck 130B, where one vehicle 110 follows another vehicle 110A at predetermined fixed distances. As an example, FIG. 1B illustrates a three vehicle 110 convoy where one vehicle closely follows another vehicle at the predetermined fixed distance.

As another example, the controller 122 may obtain images from one or more of the three-dimensional imaging system 440A, 440B, the case edge detection sensors 450A, 450B, and the case unit monitoring cameras 410A, 410B (the case unit monitoring cameras 410A, 410B forming stereo vision or binocular image cameras) to effect case handling by the vehicle 110. Still referring FIGS. 2 and 3A, the one or more case edge detection sensors 450A, 450B are any suitable sensors such as laser measurement sensors configured to scan the shelves of the storage and retrieval system 100 to verify the shelves are clear for placing case units CU, or to verify a case unit size and position before picking the case unit CU. While one case edge detection sensor 450A, 450B is illustrated on each side of the payload bed 210B centerline CLPB (see FIG. 3A) there may be more or less than two case edge detection sensors placed at any suitable locations on the autonomous transport vehicle 110 so that the vehicle 110 can traverse by and scan case units CU with the front end 200E1 leading a direction of vehicle travel or the rear/back end 200E2 leading the direction of vehicle travel. It is noted that case handling includes picking and placing case units from case unit holding locations (such as for case unit localization, verification of the case unit, and verification of placement of the case unit in the payload bed 210B and/or at a case unit holding location such as a storage shelf or buffer location).

Images from the out of plane localization cameras 477A, 477B (which may also form respective stereo image cameras) may be obtained by the controller 122 to effect navigation of the autonomous guided vehicle 110 and/or to provide data (e.g., image data) supplemental to localization/navigation data from the one or more of the forward and rearward navigation cameras 420A, 420B, 430A, 430B. Images from the one or more traffic monitoring camera 460A, 460B may be obtained by the controller 122 to effect travel transitions of the autonomous guided vehicle 110 from a picking aisle 130A to the transfer deck 130B (e.g., entry to the transfer deck 130B and merging of the autonomous guided vehicle 110 with other autonomous guided vehicles travelling along the transfer deck 130B).

The one or more out of plane (e.g., upward or downward facing) localization cameras 477A, 477B (which may also form respective stereo image cameras) are disposed on the frame 200 of the autonomous transport vehicle 110 so as to sense/detect location fiducials (e.g., location marks (such as barcodes, etc.), lines 199 (see FIG. 1B), etc.) disposed on a ceiling of the storage and retrieval system or on the rolling surface 284 of the storage and retrieval system. The location fiducials have known locations within the storage and retrieval system and may provide unique identification marks/patterns that are recognized by the vision system controller 122VC (e.g., processing data obtained from the localization cameras 477A, 477B). Based on the location fiducial detected, the vision system controller 122VC compares the detected location fiducial to known location fiducials (e.g., store in a memory of or accessible to the vision system controller 122VC) to determine a location of the autonomous transport vehicle 110 within the storage structure 130.

The one or more traffic monitoring cameras 460A, 460B (which may also form respective stereo image cameras) are disposed on the frame 200 so that a respective field of view 460AF, 460BF faces laterally in lateral direction LAT1. While the one or more traffic monitoring cameras 460A, 460B are illustrated as being adjacent a transfer opening 1199 of the transfer bed 210B (e.g., on the pick side from which the arm 210A of the autonomous transport vehicle 110 extends), in other aspects there may be traffic monitoring cameras disposed on the non-pick side of the frame 200 so that a field of view of the traffic monitoring cameras faces laterally in direction LAT2. The traffic monitoring cameras 460A, 460B provide for an autonomous merging of autonomous transport vehicles 110 exiting, for example, a picking aisle 130A or lift transfer area 195 onto the transfer deck 130B (see FIG. 1B). For example, the autonomous transport vehicle 110V leaving the lift transfer area 195 (FIG. 1B) detects autonomous transport vehicle 110T travelling along the transfer deck 130B. Here, the controller 122 autonomously strategizes merging (e.g., entering the transfer deck in front of or behind the autonomous guided vehicle 110T, acceleration onto the transfer deck based on a speed of the approaching vehicle 110T, etc.) on to the transfer deck based on information (e.g., distance, speed, etc.) of the autonomous guided vehicle 110T gathered by the traffic monitoring cameras 460A, 460B and communicated to and processed by the vision system controller 122VC.

The case unit monitoring cameras 410A, 410B are any suitable two-dimensional rolling shutter high resolution or low resolution video cameras (where video images that include more than about 480 vertical scan lines and are captured at more than about 50 frames/second are considered high resolution) such as those described herein. The case unit monitoring cameras 410A, 410B are arranged relative to each other to form a stereo vision camera system that is configured to monitor case unit CU ingress to and egress from the payload bed 210B. The case unit monitoring cameras 410A, 410B are coupled to the frame 200 in any suitable manner and are focused at least on the payload bed 210B. As can be seen in FIG. 3A, one camera 410A in the camera pair is disposed at or proximate one end or edge of the payload bed 210B (e.g., adjacent end 200E1 of the autonomous guided vehicle 110) and the other camera 410B in the camera pair is disposed at or proximate the other end or edge of the payload bed 210B (e.g., adjacent end 200E2 of the autonomous guided vehicle 110). It is noted that the distance between the cameras, e.g., on opposite sides of the payload bed 210B may be such that the disparity between the cameras 410A, 410B in the stereo image cameras is about 700 pixels (in other aspects the disparity may be more or less than about 700 pixels, noting that disparity between conventional stereo image cameras is less than about 255 pixels and is typically much smaller at about 96 pixels). The increased disparity between cameras 410A, 410B compared to conventional stereo image cameras may increase the resolution of disparity from pixel matching (such as when generating a depth map as described herein) where upon the rectification of the pixel matching, the resolution for pixels in the field of view of the cameras is improved in accuracy, for objects located near the cameras (near field) and objects located far from the cameras (far field), compared to conventional binocular camera systems. For example, referring also to FIG. 4B, the increased disparity between cameras 410A, 410B in accordance with the aspects of the disclosed embodiment provide for a resolution of about 1 mm (e.g., about 1 mm disparity error) at a front (e.g., a side of the holding location closest to the autonomous guided vehicle 110) of the a case holding location (such as a storage shelf of a storage rack or other case holding location of the storage and retrieval system 100) and a resolution of about 3 mm (e.g., about 3 mm of disparity error) at a rear (e.g., a side of the holding location further from the autonomous guided vehicle 110) of the case holding location.

The robustness of the vision system 400 accounts for determination or otherwise identification of object location and pose given the above-noted disparity between the stereo image cameras 410A, 410B. In one or more aspects, the case unit monitoring (stereo image) cameras 410A, 410B are coupled to the transfer arm 210A so as move in direction LAT with the transfer arm 210A (such as when picking and placing case units CU) and are positioned so as to be focused on the payload bed 210B and support tines 210AT of the transfer arm 210A. In one or more aspects, closely spaced (e.g., less than about 255 pixel disparity) off the shelf camera pairs may be employed.

Referring also to FIG. 5A, the case unit monitoring cameras 410A, 410B effect at least in part one or more of case unit determination, case unit localization, case unit position verification, and verification of the case unit justification features (e.g., justification blades 471 and pushers 470) and case transfer features (e.g., tines 210AT, pullers 472, and payload bed floor 473). For example, the case unit monitoring cameras 410A, 410B detect one or more of case unit length CL, CL1, CL2, CL3, a case unit height CH1, CH2, CH3, and a case unit yaw YW (e.g., relative to the transfer arm 210A extension/retraction direction LAT). The data from the case handling sensors (e.g., noted above) may also provide the location/positions of the pushers 470, pullers 472, and justification blades 471, such as where the payload bed 210B is empty (e.g., not holding a case unit).

The case unit monitoring cameras 410A, 410B are also configured to effect, with the vision system controller 122VC, a determination of a front face case center point FFCP (e.g., in the X, Y, and Z directions with respect to, e.g., the autonomous guided vehicle 110 reference frame BREF (see FIG. 3A) with the case units disposed on a shelf or other holding area off-board the vehicle 110) relative to a reference location of the autonomous guided vehicle 110. The reference location of the autonomous guided vehicle 110 may be defined by one or more justification surfaces of the payload bed 210B or the centerline CLPB of the payload bed 210B. For example, the front face case center point FFCP may be determined along the longitudinal axis LAX (e.g. in the Y direction) relative to a centerline CLPB of the payload bed 210B (FIG. 3A). The front face case center point FFCP may be determined along the vertical axis VER (e.g. in the Z direction) relative to a case unit support plane PSP of the payload bed 210B (FIGS. 3A and 3B—formed by one or more of the tines 210AT of the transfer arm 210A and the payload bed floor 473). The front face case center point FFCP may be determined along the lateral axis LAT (e.g. in the X direction) relative to a justification plane surface JPP of the pushers 470 (FIG. 3B). Determination of the front face case center point FFCP of the case units CU located on a storage shelf 555 (see FIGS. 3A and 4A) or other case unit holding location provides, as non-limiting examples, for localization of the autonomous guided vehicle 110 relative to case units CU to be picked, mapping locations of case units within the storage structure (e.g., such as in a manner similar to that described in U.S. Pat. No. 9,242,800 issued on Jan. 26, 2016 titled “Storage and retrieval system case unit detection”, the disclosure of which is incorporated herein by reference in its entirety), and/or pick and place accuracy relative to other case units on the storage shelf 555 (e.g., so as to maintain predetermined gap sizes between case units.

The determination of the front face case center point FFCP also effects a comparison of the “real world” environment in which the autonomous guided vehicle 110 is operating with a virtual model 400VM of that operating environment so that controller 122 of the autonomous guided vehicle 110 compares what is “sees” with the vision system 400 substantially directly with what the autonomous guided vehicle 110 expects to “see” based on the simulation of the storage and retrieval system structure in a manner similar to that described in U.S. patent application Ser. No. 17/804,026 filed on May 25, 2022 and titled “Autonomous Transport Vehicle with Vision System” (having attorney docket number 1127P016037-US (PAR)), the disclosure of which is incorporated herein by reference in its entirety. Moreover, in one aspect, illustrated in FIG. 5A, the object (case unit) and characteristics determined by the vision system controller 122VC are coapted (combined, overlayed) to the virtual model 400VM enhancing resolution, in up to six degrees of freedom resolution, of the object pose with respect to a facility or global reference frame GREF (see FIG. 2). As may be realized, registration of the cameras of the vision system 400 with the global reference frame GREF (as described herein) allows for enhanced resolution of vehicle 110 pose and/or location with respect to both a global reference (facility features rendered in the virtual model 400VM) and the imaged object. More particularly, object position discrepancies or anomalies apparent and identified upon coapting the object image and virtual model 400VM (e.g., edge spacing between case unit fiducial edges or case unit inclination or skew, with respect to the rack slats 520L of the virtual model 400VM), if greater than a predetermined nominal threshold, describe an errant pose of one or more of case, rack, and/or vehicle 110. Discrimination as to whether errancy is with the pose/location of the case, rack or vehicle 110, one or more is determined via comparison with pose data from sensors 270 and supplemental navigation sensor system 288.

As an example of the above-noted enhanced resolution, if one case unit disposed on a shelf that is imaged by the vision system 400 is turned compared to juxtaposed case units on the same shelf (also imaged by the vision system) and to the virtual model 400VM the vision system 400 may determine the one case is skewed (see FIG. 4A) and provide the enhanced case position information to the controller 122 for operating the transfer arm 210A and positioning the transfer arm 210A so as to pick the one case based on the enhanced resolution of the case pose and location. As another example, if the edge of a case is offset from a slat 520L (see FIG. 4A-4C) edge by more than a predetermined threshold the vision system 400 may generate a position error for the case; noting that if the offset is within the threshold, the supplemental information from the supplemental navigation sensor system 288 enhances the pose/location resolution (e.g., an offset substantially equal to the determined pose/location of the case with respect to the slat 520L and vehicle 110 payload bed 210B transfer arm 210A frame. It is further noted that if only one case is skewed/offset relative to the slat 520L edges the vision system may generate the case position error; however, if two or more juxtaposed cases are determined to be skewed relative to the slat 520L edges the vision system may generate a vehicle 110 pose error and effect repositioning of the vehicle 110 (e.g., correct the position of the vehicle 110 based on an offset determined from the supplemental navigation sensor system 288 supplemental information) or a service message to an operator (e.g., where the vision system 400 effects a “dashboard camera” collaborative mode (as described herein) that provides for remote control of the vehicle 110 by an operator with images (still and/or real time video) from the vision system being conveyed to the operator to effect the remote control operation). The vehicle 110 may be stopped (e.g., does not traverse the picking aisle 130A or transfer deck 130B) until the operator initiates remote control of the vehicle 110.

The case unit monitoring cameras 410A, 410B may also provide feedback with respect to the positions of the case unit justification features and case transfer features of the autonomous guided vehicle 110 prior to and/or after picking/placing a case unit from, for example, a storage shelf or other holding locations (e.g., for verifying the locations/positions of the justification features and the case transfer features so as to effect pick/place of the case unit with the transfer arm 210A without transfer arm obstruction). For example, as noted above, the case unit monitoring cameras 410A, 410B have a field of view that encompasses the payload bed 210B. The vision system controller 122VC is configured to receive sensor data from the case unit monitoring cameras 410A, 410B and determine, with any suitable image recognition algorithms stored in a memory of or accessible by the vision system controller 122VC, positions of the pushers 470, justification blades 471, pullers 472, tines 210AT, and/or any other features of the payload bed 210B that engage a case unit held on the payload bed 210B. The positions of the pushers 470, justification blades 471, pullers 472, tines 210AT, and/or any other features of the payload bed 210B may be employed by the controller 122 to verify a respective position of the pushers 470, justification blades 471, pullers 472, tines 210AT, and/or any other features of the payload bed 210B as determined by motor encoders or other respective position sensors; while in some aspects the positions determined by the vision system controller 122VC may be employed as a redundancy in the event of encoder/position sensor malfunction.

The justification position of the case unit CU within the payload bed 210B may also be verified by the case unit monitoring cameras 410A, 410B. For example, referring also to FIG. 3C, the vision system controller 122VC is configured to receive sensor data from the case unit monitoring cameras 410A, 410B and determine, with any suitable image recognition algorithms stored in a memory of or accessible by the vision system controller 122VC, a position of the case unit in the X, Y, Z directions relative to, for example, one or more of the centerline CLPB of the payload bed 210B, a reference/home position of the justification plane surface JPP (FIG. 3B) of the pushers 470, and the case unit support plane PSP (FIGS. 3A and 3B). Here, position determination of the case unit CU within the payload bed 210B effects at least place accuracy relative to other case units on the storage shelf 555 (e.g., so as to maintain predetermined gap sizes between case units.

Referring to FIGS. 2, 3A, 3B, and 5, the one or more three-dimensional imaging system 440A, 440B includes any suitable three-dimensional imager(s) including but not limited to, e.g., time-of-flight cameras, imaging radar systems, light detection and ranging (LIDAR), etc. The one or more three-dimensional imaging system 440A, 440B provides for enhanced autonomous guided vehicle 110 localization with respect to, for example, a global reference frame GREF (see FIG. 2) of the storage and retrieval system 100. For example, the one or more three-dimensional imaging system 440A, 440B may effect, with the vision system controller 122VC, a determination of a size (e.g., height and width) of the front face (i.e., the front face surface) of a case unit CU and front face case center point FFCP (e.g., in the X, Y, and Z directions) relative to a reference location of the autonomous guided vehicle 110 and invariant of a shelf supporting the case unit CU (e.g., the one or more three-dimensional imaging system 440A, 440B effects case unit CU location (which location of the case units CU within the automated storage and retrieval system 100 is defined in the global reference frame GREF) without reference to the shelf supporting the case unit CU and effects a determination as to whether the case unit is supported on a shelf through a determination of a shelf invariant characteristic of the case units). Here, the determination of the front face surface and case center point FFCP also effects a comparison of the “real world” environment in which the autonomous guided vehicle 110 is operating with the virtual model 400VM so that controller 122 of the autonomous guided vehicle 110 compares what is “sees” with the vision system 400 substantially directly with what the autonomous guided vehicle 110 expects to “see” based on the simulation of the storage and retrieval system structure as described in U.S. patent application Ser. No. 17/804,026 filed on May 25, 2022 and titled “Autonomous Transport Vehicle with Vision System” (having attorney docket number 1127P016037-US (PAR)), the disclosure of which was previously incorporated herein by reference in its entirety. The image data obtained from the one or more three-dimensional imaging system 440A, 440B may supplement and/or enhance the image data from the cameras 410A, 410B in the event data from the cameras 410A, 410B is incomplete or missing. Here, the object detection and localization with respect to autonomous guided vehicle 110 pose within the global reference frame GREF may be determined with high accuracy and confidence by the one or more three-dimensional imaging system 440A, 440B; however, in other aspects, the object detection and localization may be effected with one or more sensors of the physical characteristic sensor system 270 and/or wheel encoders/inertial sensors of the autonomous guided vehicle 110.

As illustrated in FIG. 5, the one or more three-dimensional imaging system 440A, 440B has a respective field of view that extends past the payload bed 210B substantially in direction LAT so that each three-dimensional imaging system 440A, 440B is disposed to sense case units CU adjacent to but external of the payload bed 210B (such as case units CU arranged so as to extend in one or more rows along a length of a picking aisle 130A (see FIG. 5A) or a substrate buffer/transfer stations (similar in configuration to storage racks 599 and shelves 555 thereof disposed along the picking aisles 130A) arranged along the transfer deck 130B). The field of view 440AF, 440BF of each three-dimensional imaging system 440A, 440B encompasses a volume of space 440AV, 440BV that extends a height 670 of a pick range of the autonomous guided vehicle 110 (e.g., a range/height in direction VER—FIG. 2—in which the arm 210A can move to pick/place case units to a shelf or stacked shelves accessible from a common rolling surface 284 (e.g., of the transfer deck 130B or picking aisle 130A—see FIG. 2) on which the autonomous guided vehicle 110 rides).

It is noted that data from the one or more three-dimensional imaging system 440A, 440B may be supplemental to the object determination and localization described herein with respect to the stereo pairs of cameras. For example, the three-dimensional imaging system 440A, 440B may be employed for pose and location verification that is supplemental to the pose and location determination made with the stereo pairs of cameras, such as during stereo image cameras calibration or an autonomous guided vehicle pick and place operation. The three dimensional imaging system 440A, 440B may also provide a reference frame transformation so that object pose and location determined in the autonomous guided vehicle reference frame BREG can be transformed into a pose and location within the global reference frame GREF, and vice versa. In other aspects, the autonomous guided vehicle may be sans the three-dimensional imaging system.

The vision system 400 may also effect operational control of the autonomous transport vehicle 110 in collaboration with an operator. The vision system 400 provides data (images) and that vision system data is registered by the vision system controller 122VC that (a) determines information characteristics (in turn provided to the controller 122), or (b) information is passed to the controller 122 without being characterized (objects in predetermined criteria) and characterization is done by the controller 122. In either (a) or (b) it is the controller 122 that determines selection to switch to the collaborative state. After switching, the collaborative operation is effected by a user accessing the vision system 400 via the vision system controller 122VC and/or the controller 122 through a user interface UI. In its simplest form, however, the vision system 400 may be considered as providing a collaborative mode of operation of the autonomous transport vehicle 110. Here, the vision system 400 supplements the autonomous navigation/operation sensor system 270 to effect collaborative discriminating and mitigation of objects/hazards 299 (see FIG. 3A, where such objects/hazards includes fluids, cases, solid debris, etc.), e.g., encroaching upon the travel/rolling surface 284 as described in U.S. patent application Ser. No. 17/804,026 filed on May 25, 2022 and titled “Autonomous Transport Vehicle with Vision System” (having attorney docket number 1127P016037-US (PAR)), the disclosure of which was previously incorporated herein by reference in its entirety.

In one aspect, the operator may select or switch control of the autonomous guided vehicle (e.g., through the user interface UI) from automatic operation to collaborative operation (e.g., the operator remotely controls operation of the autonomous transport vehicle 110 through the user interface UI). For example, the user interface UI may include a capacitive touch pad/screen, joystick, haptic screen, or other input device that conveys kinematic directional commands (e.g., turn, acceleration, deceleration, etc.) from the user interface UI to the autonomous transport vehicle 110 to effect operator control inputs in the collaborative operational mode of the autonomous transport vehicle 110. For example, the vision system 400 provides a “dashboard camera” (or dash-camera) that transmits video and/or still images from the autonomous transport vehicle 110 to an operator (through user interface UI) to allow remote operation or monitoring of the area relative to the autonomous transport vehicle 110 in a manner similar to that described in U.S. patent application Ser. No. 17/804,026 filed on May 25, 2022 and titled “Autonomous Transport Vehicle with Vision System” (having attorney docket number 1127P016037-US (PAR)), the disclosure of which was previously incorporated herein by reference in its entirety.

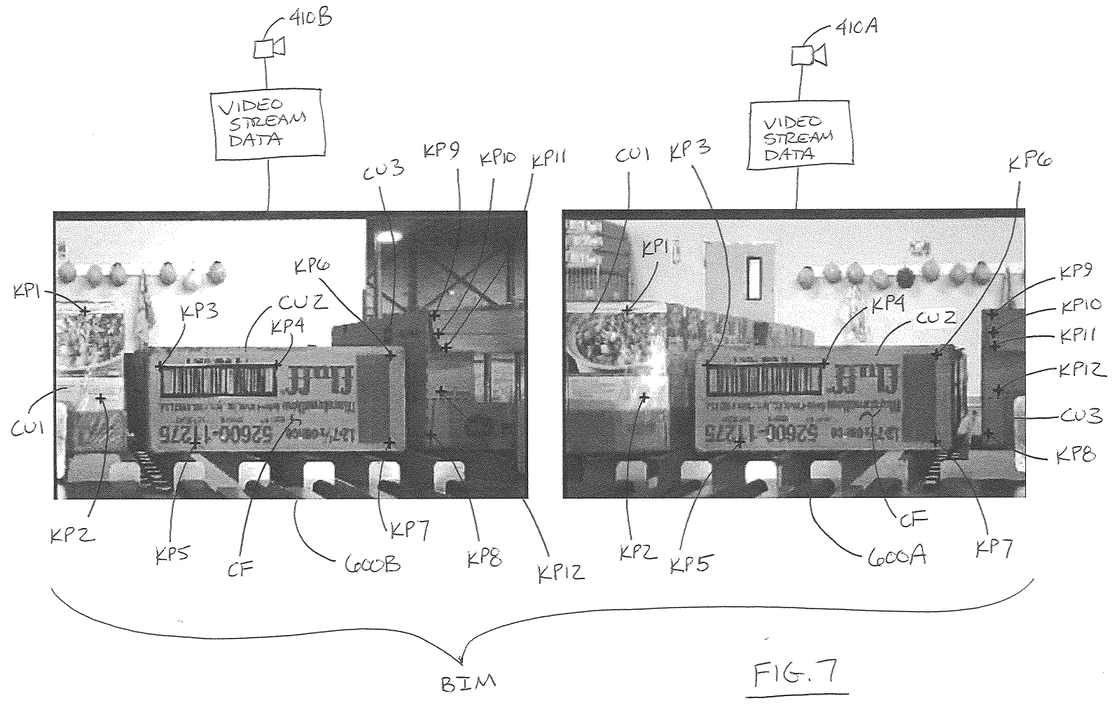

Referring to FIG. 1A, as described above, the autonomous guided vehicle 110 is provided with the vision system 400 that has an architecture based on camera pairs (e.g., such as camera pairs 410A and 410B, 420A and 420B, 430A and 430B, 460A and 460B, 477A and 477B), disposed for stereo or binocular object detection and depth determination (e.g., through employment of both disparity/dense depth maps from registered video frame/images captured with the respective cameras and keypoint data determined from the registered video frame/images captured with the respective cameras). The object detection and depth determination provides for the localization (e.g., pose and location determination or identification) of the object (e.g., at least case holding locations such as e.g., on shelves and/or lifts, and cases to be picked) relative to the autonomous guided vehicle 110. As described herein, the vision system controller 122VC is communicably connected to the vision system 400 so as to register (in any suitable memory) binocular images BIM (examples of binocular images are illustrated in FIGS. 6 and 7) from the vision system 400. As will be described herein, the vision system controller 122VC is configured to effect stereo mapping (also referred to as disparity mapping), from the binocular images BIM, resolving a dense depth map 620 (see FIG. 6) of imaged objects in the field of view. As will also be described herein, the vision system controller 122VC is configured to detect from the binocular images BIM, stereo sets of keypoints KP1-KP12 (see FIG. 7), each set of keypoints (see the keypoint set in image frame 600A and the keypoint set in image frame 600B—see FIG. 7) setting out, separate and distinct from each other set of keypoints, a common predetermined characteristic (e.g., such as a corner, edge, a portion of text, a portion of a barcode, etc.) of each imaged object, so that the vision system controller 122VC determines from the stereo sets of keypoints KP1-KP12 depth resolution of each object separate and distinct from the dense depth map 620.

Referring also to FIGS. 3A, 3B, 6 and 7, as noted above, the vision system controller 122VC, which may be part of controller 122 or otherwise communicably connected to controller 122, registers the image data from the camera pairs. The camera pair 410A and 410B, disposed to view at least the payload bed 210B, will be referred to for illustrative purposes; however, it should be understood that the other camera pairs 420A and 420B, 430A and 430B, 460A and 460B, 477A and 477B effect object pose and location detection (or identification) in a substantially similar manner. Here, the controller 122VC registers the binocular images (e.g., such as in the form of video stream data) from the cameras 410A, 410B and parses the video stream data into stereo image frame (e.g., still image) pairs, again noting that the cameras 410A, 410B are not synchronized with each other (noting synchronization of the cameras is when the cameras are configured, relative to each other, to capture corresponding image frames (still or motion video) simultaneously, i.e., the camera shutters for each camera in the pair are actuated and de-actuated simultaneously in synchronization). The vision system controller 122VC is configured to process the image data from each camera 410A, 410B so that image frames 600A, 600B are parsed from the respective video stream data as a temporally matched stereo image pair 610.

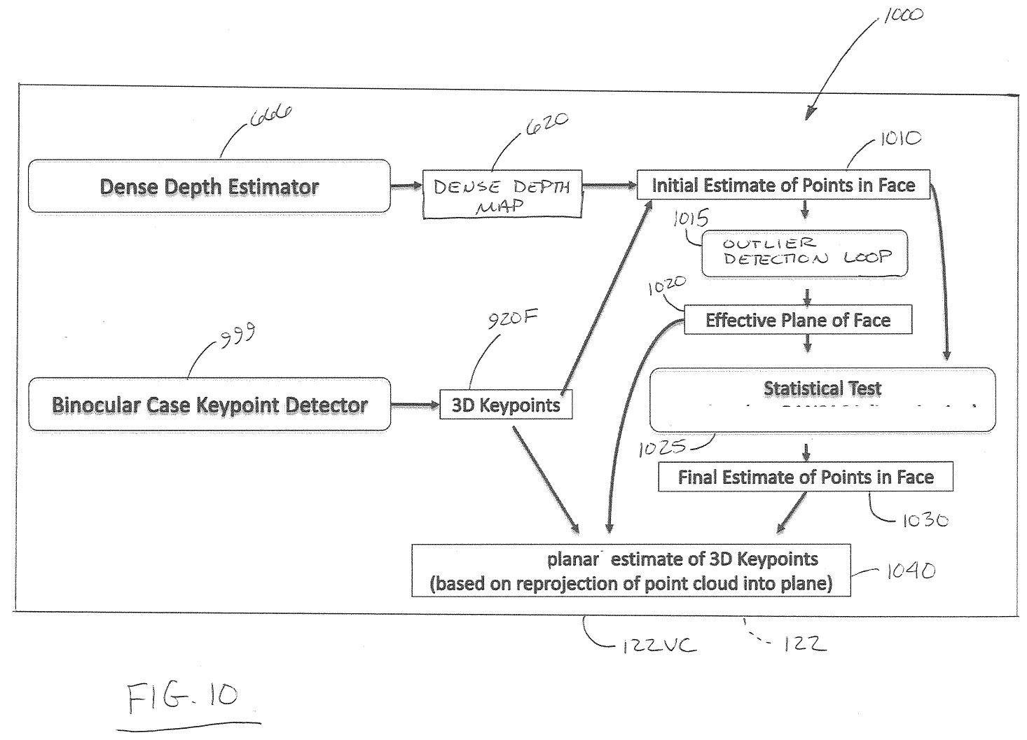

Referring to FIGS. 3A, 3B, and 6, the vision system controller 122VC is configured with an object extractor 1000 (FIG. 10) that includes a dense depth estimator 666. The dense depth estimator 666 configures the vision system controller 122VC to generate a depth map 620 from the stereo image pair 610, where the depth map 620 embodies objects within the field of view of the cameras 410A, 410B. The depth map 620 may be a dense depth map generated in any suitable manner such as from a point cloud obtained by disparity mapping the pixels/image points of each image 600A, 600B in the stereo image pair 610. The image points within the images 600A, 600B may be obtained and matched (e.g., pixel matching) in any suitable manner and with any suitable algorithm stored in and executed by the controller 122VC (or controller 122). Exemplary algorithms include, but are not limited to RAFT-Stereo, HITNet, AnyNet®, StereoNet, StereoDNN (also known as Stereo Depth DNN), Semi-Global Matching (SGM), or in any other suitable manner such as employment of any of the stereo matching methods listed in Appendix A, all of which are incorporated herein by reference in their entireties, and one or more of which may be deep learning methods (e.g., that include training with suitable models) or approaches that do not employ learning (e.g., no training). Here, the cameras 410A, 410B in the stereo image cameras are calibrated with respect to each other (in any suitable manner such as described herein) so that the epipolar geometry describing the relationship between stereo pairs of images taken with the cameras 410A, 410B is known and the images 600A, 600B of the image pair are rectified with respect to each other, effecting depth map generation. As noted above, the dense depth map is generated with an unsynchronized camera pair 410A and 410B (e.g., while the images 600A, 600B may be close in time they are not synchronized). As such, if one image 600A, 600B in the image pair is blocked, blurred, or otherwise unusable, the vision system controller 122VC obtains another image pair (i.e., subsequent to image pair 600A, 600B) of the binocular image pairs, parsed from the registered image data, if such subsequent images are not blocked (e.g., the loop continues until an unblocked parsed image pair is obtained), the dense depth map 620 is generated (noting the keypoints described herein are determined from the same image pair used to generate the depth map).

The dense depth map 620 is “dense” (e.g., has a depth of resolution for every, or near every, pixel in an image) compared to a sparse depth map (e.g., stereo matched keypoints) and has a definition commensurate with discrimination of objects, within the field of view of the cameras, that effects resolution of pick and place actions of the autonomous guided vehicle 110. Here, the density of the dense depth map 620 may depend on (or be defined by) the processing power and processing time available for object discrimination. As an example, and as noted above, transfer of objects (such as case units CU) to and from the payload bed 210B of the autonomous guided vehicle 110, from bot traverse stopping to bot traverse starting, is performed in about 10 seconds or less. For transfer of the objects, the transfer arm 210A motion is initiated prior to stopping traverse of the autonomous guided vehicle 110 so that the autonomous guided vehicle is positioned adjacent the pick/place location where the object (e.g., the holding station location and pose, the object/case unit location pose, etc.) is to be transferred and the transfer arm 210A is extended substantially coincident with the autonomous guided vehicle stopping. Here, at least some of the images captured by the vision system 400 (e.g., for discriminating an object to be picked, a case holding location, or other object of the storage and retrieval system 100) are captured with the autonomous guided vehicle traversing a traverse surface (i.e., with the autonomous guided vehicle 110 in motion along a transfer deck 130B or picking aisle 130A and moving past the objects). The discrimination of the object occurs substantially simultaneously with stopping (e.g., occurs at least partly with the autonomous guided vehicle 110 in motion and decelerating from a traverse speed to a stop) of the autonomous guided vehicle such that generation of the dense depth map is resolved (e.g., in less than about two seconds, or less than about half a second), for discrimination of the object, substantially coincident with the autonomous guided vehicle stopping traverse and the transfer arm 210A motion initiation. The resolution of the dense depth map 620 renders (informs) the vision system controller 122VC (and controller 122) of anomalies of the object, such as from the object face (see the open case flap and tape on the case illustrated in FIG. 6 or other anomalies including but not limited to tears in the case front, appliques (such as tape or other adhered overlays) on the case front) with respect to an autonomous guided vehicle command (e.g., such as a pick/place command). The resolution of the dense depth map 620 may also provide for stock keeping unit (SKU) identification where the vision system controller 122VC determines the front face dimensions of a case and determines the SKU based on the front face dimensions (e.g., SKUs are stored in a table with respective front face dimensions, such that the SKUs are correlated to the respective front face dimensions and the vision system controller 122VC or controller 122 compares the determined front face dimensions with those front face dimensions in the table to identify which SKU is correlated to the determined front face dimensions).

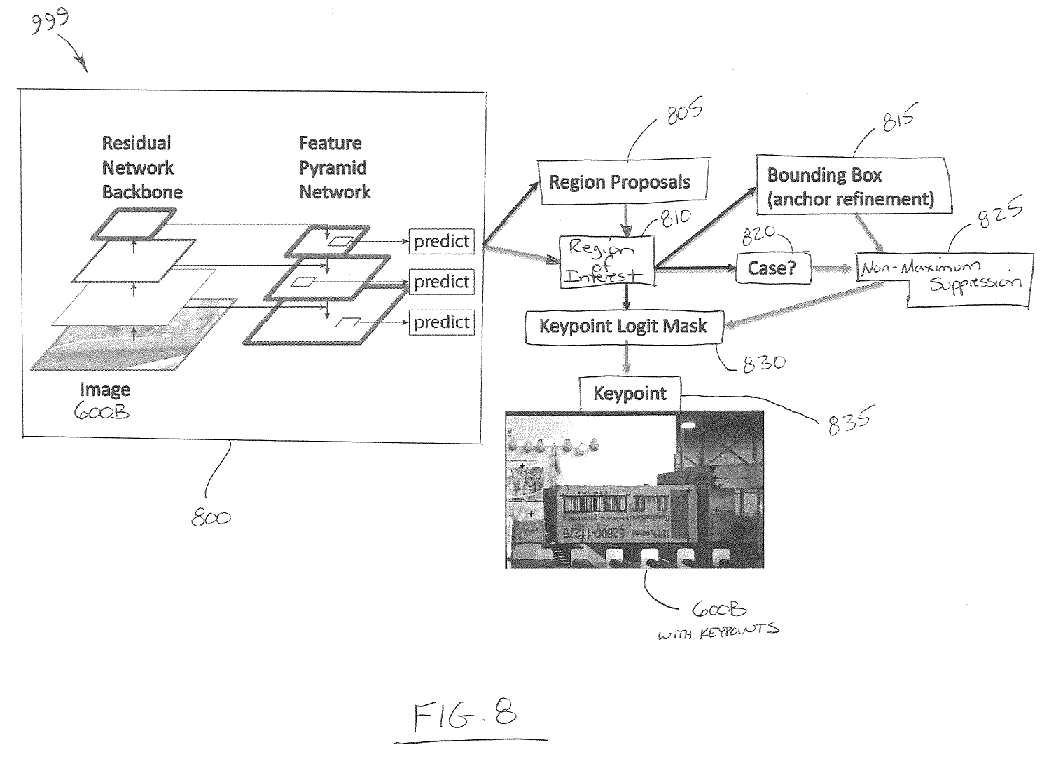

As noted above, and referring to FIGS. 3A, 3B, 6, 7, 8, and 9, the vision system controller 122VC is configured with the object extractor 1000 (see FIG. 10) that includes a binocular case keypoint detector 999. The binocular case keypoint detector 999 configures the vision system controller 122VC to detect from the binocular images 600A, 600B, stereo sets of keypoints (see FIG. 7 and exemplary keypoints KP1, KP2 forming one keypoint set, keypoints KP3-KP7 forming another keypoint set, and keypoints KP8-KP12 forming yet another keypoint set; noting that a keypoint is also referred to as a “feature point,” an “invariant feature,” an “invariant point,” or a “characteristic” (such as a corner or facet joint or object surface)). Each set of keypoints setting out, separate and distinct from each other keypoint set, a common predetermined characteristic of each imaged object (here cases CU1, CU2, CU3), so that the vision system controller 122VC determines from the stereo sets of keypoints depth resolution of each object CU1, CU2, CU3 separate and distinct from the dense depth map 620. The keypoint detection algorithm may be disposed within the residual network backbone (see FIG. 8) of the vision system 400, where a feature pyramid network for feature/object detection (see FIG. 8) is employed to predict or otherwise resolve keypoints for each image 600A, 600B separately. Keypoints for each image 600A, 600B may be determined in any suitable manner with any suitable algorithm, stored in the controller 122VC (or controller 122), including but not limited to Harris Corner Detector, Microsoft COCO (Common Objects in Context), other deep learning and logistics models or other corner detection methods. It is noted that suitable examples of corner detection methods may be informed by deep learning methods or may be corner detection approaches that do not use deep learning. As noted above, at least some of the images captured by the vision system 400 (e.g., for discriminating an object to be picked, a case holding location, or other object of the storage and retrieval system 100) are captured with the autonomous guided vehicle traversing a traverse surface (i.e., with the autonomous guided vehicle 110 in motion along a transfer deck 130B or picking aisle 130A and moving past the objects). The discrimination of the object occurs substantially simultaneously with stopping (e.g., occurs at least partly with the autonomous guided vehicle 110 in motion and decelerating from a traverse speed to a stop) of the autonomous guided vehicle such that detection of the keypoints is resolved (e.g., in less than about two seconds, or less than about half a second), for discrimination of the object, substantially coincident with the autonomous guided vehicle stopping traverse and the transfer arm 210A motion initiation.

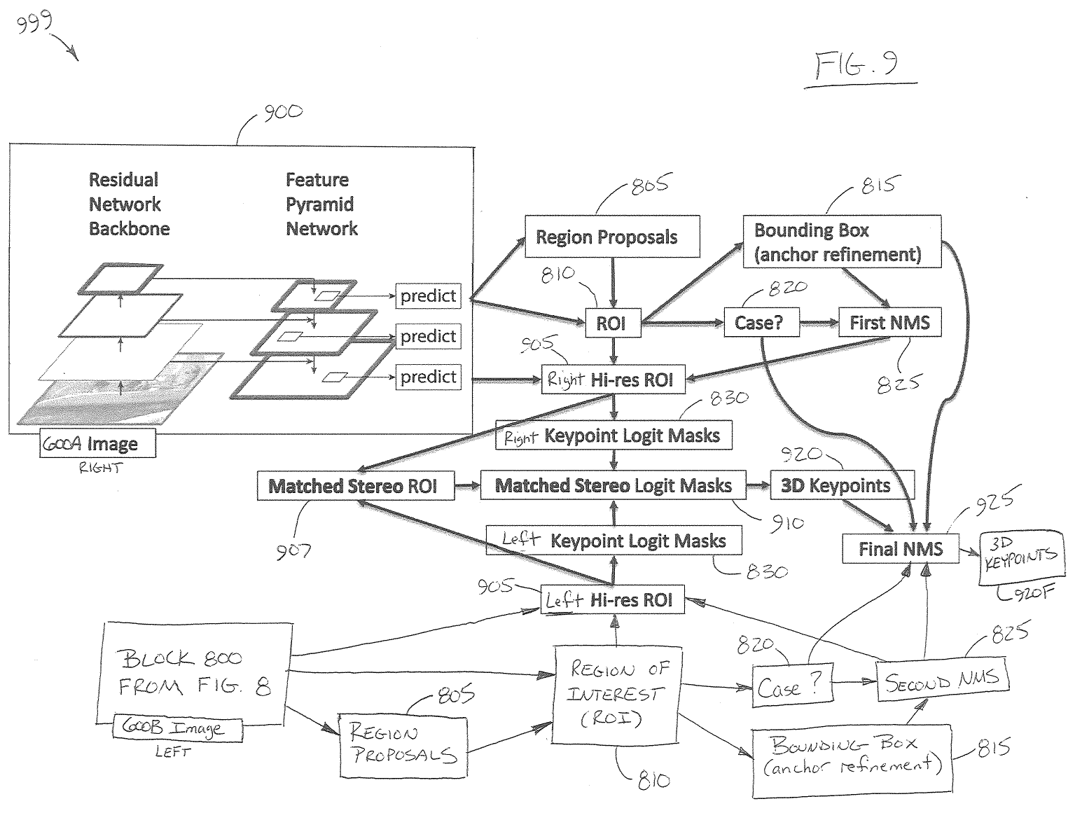

As can be seen in FIGS. 8 and 9, keypoint detection is effected separate and distinct from the dense depth map 620. For each camera image 600A, 600B, separate and distinct from each other camera image 600A, 600B, keypoints are detected in the image frame to form a stereo pair or set of keypoints from the stereo images 600A, 600B. FIG. 8 illustrates an exemplary keypoint determination flow diagram for image 600B, noting that such keypoint determination is substantially similar for image 600A. In the keypoint detection the residual network backbone and feature pyramid network provide predictions (FIG. 8, Block 800) for region proposals (FIG. 8, Block 805) and regions of interest (FIG. 8, Block 810). Bounding boxes are provided (FIG. 8, Block 815) for objects in the image 600B and suspected cases are identified (FIG. 8, Block 820). A non-maximum suppression (NMS) is applied (FIG. 8, Block 825) to the bounding boxes (and suspected cases or portions thereof identified with the bounding boxes) to filter the results, where such filtered results and the region of interest are input into a keypoint logit mask (FIG. 8, Block 830) for keypoint determination (FIG. 8, Bock 835) (e.g., such as with deep learning, or in other aspects without deep learning in the exemplary manners described herein).

FIG. 9 illustrates an exemplary keypoint determination flow diagram for keypoint determination in both images 600A and 600B (the keypoints for image 600A being determined separately from the keypoints for image 600B, where the keypoints in each image are determined in a manner substantially similar that described above with respect to FIG. 8). The keypoint determinations for image 600A and image 600B may be performed in parallel or sequentially (e.g., Blocks 800, 900, 805-830 may be performed in parallel or sequentially) so outputs of the respective keypoint logit masks 830 are employed by the vision system controller 122VC as input to matched stereo logit masks (FIG. 9, Block 910) for determination of the stereo (three-dimensional) keypoints (FIG. 9, Block 920). High-resolution regions of interest (FIG. 9, Blocks 905) may be determined/predicted by the residual network backbone and feature pyramid network based on the respective region of interest (Block 810), where the high-resolution region of interest (Block 905) is input to the respective keypoint logic masks 830. The vision system controller 122VC generates a matched stereo region of interest (FIG. 9, Block 907) based on the regions of interest (Blocks 905) for each image 600A, 600B, where the matched stereo region of interest (Block 907) is input to the matched stereo logit masks (Block 910) for determination of the stereo (three-dimensional) keypoints (Block 920). The high-resolution regions of interest from each image 600A, 600B may be matched via pixel matching or in any other suitable manner to generate the matched stereo region of interest (Block 907). Another non-maximum suppression (NMS) is applied (FIG. 9, Block 925) to filter the keypoints and obtain a final set of stereo matched keypoints 920F, an example of which are the stereo matched keypoints KP1-KP12 (also referred to herein as stereo sets of keypoints) illustrated in FIG. 7.

Referring to FIGS. 4A, 6, and 7, the stereo matched keypoints KP1-KP12 are matched to generate a best fit (e.g., depth identification for each keypoint). Here, the stereo matched keypoints KP1-KP12 resolve at least a case face CF and a depth of each stereo matched keypoint KP1-KP12 (which may effect front face case center point FFCP determination) with respect to a predetermined reference frame (e.g., such as the autonomous guided vehicle reference frame BREF (see FIG. 3A) and/or a global reference frame GREF (see FIG. 4A) of the automated storage and retrieval system 100, the autonomous guided vehicle reference frame BREF being related (i.e., a transformation is determined as described herein) to the global reference frame GREF so that a pose and location of objects detected by the autonomous guided vehicle 110 is known in both the global reference frame GREF and the autonomous guided vehicle reference frame BREF). As described herein, the resolved stereo matched keypoints KP1-KP12 are separate and distinct from the dense depth map 620 and provide a separate and distinct solution, for determining object (such as case CU) pose and depth/location, than the solution provided by the dense depth map 620, but both solutions being provided from a common set of stereo images 600A, 600B.

Referring to FIGS. 6, 7, and 10, the vision system controller 122VC has an object extractor 1000 configured to determine the location and pose of each imaged object (such as cases CU or other objects of the automated storage and retrieval system 100 that are located within the fields of view of the cameras 410A, 410B) from both the dense depth map 620 resolved from the binocular images 600A, 600B and the depth resolution from the matched stereo keypoints 620F. For example, the vision system controller 122VC is configured to combine the dense depth map 620 (from the dense depth estimator 666) and the matched stereo keypoints 920F (from the binocular case keypoint detector 999) in any suitable manner. The depth information from the matched stereo keypoints 920F is combined with the depth information from the dense depth map 620 for one or more objects in the images 600A, 600B, such as case CU2 so that an initial estimate of the points in the case face CF is determined (FIG. 10, Block 1010). An outlier detection loop (FIG. 10, Block 1015) is performed on the initial estimate of points in the case face CF to generate an effective plane of the case face (FIG. 10, Block 1020). The outlier detection loop may be any suitable outlier algorithm (e.g., such as RANSAC or any other suitable outlier/inlier detection method) that identifies points in the initial estimate of points in the case face as inliers and outliers, the inliers being within a predetermined best fit threshold and the outliers being outside the predetermined best fit threshold. The effective plane of the case face may be defined by a best fit threshold of about 75% of the points in the initial estimate of the points in the case face being included in the effective plane of the case face (in other aspects the best fit threshold may be more or less than about 75%). Any suitable statistical test (similar to the outlier detection loop noted above but with a less stringent criteria) is performed (FIG. 10, Block 1025) on the effective plane (again best fitting points based on subsequent predetermined best fit threshold) of the case face so that about 95% (in other aspects the subsequent best fit threshold may be more or less than about 95%) of the points (some of which may have been outliers in the outlier detection loop) are included in and define a final estimate (e.g., best fit) of the points in the case face (FIG. 10, Block 1030). The remaining points (beyond the about 95%) may also be analyzed so that points a predetermined distance from the determined case face CF are included in the final estimate of points in the face. For example, the predetermined distance may be about 2 cm so that points corresponding to an open flap or other case deformity/anomaly are included in the final estimate of points in the face and inform the vision system controller 122VC that an open flap or other case deformity/anomaly is present (in other aspects the predetermined distance may be greater than or less than about 2 cm).

The final (best fit) of the points in the case face (Block 1030) may be verified (e.g., in a weighted verification that is weighted towards the matched stereo keypoints 920F, see also keypoints KP1-KP12, which are exemplary of the matched stereo keypoints 920F). For example, the object extractor 1000 is configured to identify location and pose (e.g., with respect to a predetermined reference frame such as the global reference frame GREF and/or the autonomous guided vehicle reference ref BREF) of each imaged object based on superpose of the matching stereo (sets of) keypoints (and the depth resolution thereon) and the depth map 620. Here, the matched or matching stereo keypoints KP1-KP12 are superposed with the final estimate of the points in the case face (Block 1030) (e.g., the point cloud forming the final estimate of the points in the case face are projected into the plane formed by the matching stereo keypoints KP1-KP12) and resolved for comparison with the points in the case face so as to determine whether the final estimate of the points in the case face are within a predetermined threshold distance from the matching stereo keypoints KP1-KP12 (and the case face formed thereby). Where the final estimate of the points in the face are within the predetermined threshold distance, the final estimate of the points in the face (that define the determined case face CF) is verified and forms a planar estimate of the matching stereo keypoints (FIG. 10, Block 1040). Where the final estimate of the points in the face are outside the predetermined threshold, the final estimate of the points in the face are discarded or refined (e.g., refined by reducing the best fit thresholds described above or in any other suitable manner). In this manner, the determined pose and location of the case face CF is weighted towards the matching stereo keypoints KP1-KP12.

Referring again to FIGS. 4A and 10, the vision system controller 122VC is configured to determine the front face, of at least one extracted object, and the dimensions of the front face based on the planar estimation of the matching stereo keypoints (Block 1040). For example, FIG. 4 is illustrative of the planar estimation of the matching stereo keypoints (Block 1040) for various extracted objects (e.g., cases CU1, CU2, CU3, storage shelf hats 444, support slats 520L, storage shelf 555, etc.) Referring to case CU2, as an example, the vision system controller 122VC determines the case face CF of the case CU2 and the dimensions CL2, CH2 of the case face CF. As described herein, the determined dimensions CL2, CH2 of the case CU2 may be stored in a table such that the vision system controller 122VC is configured to determine a logistic identity (e.g., stock keeping unit) of the extracted object (e.g., case CU2) based on dimensions CL2, CH2 of the front or case face CF in a manner similar to that described herein.

The vision system controller 122VC may also determine, from the planar estimation of the matching stereo keypoints (Block 1040), the front face case center point FFCP and other dimensions/features (e.g., space envelope ENV between the hats 444, case support plane, distance DIST between cases, case skewing, case deformities/anomalies, etc.), as described herein, that effect case transfer between the storage shelf 555 and the autonomous guided vehicle 110. For example, the vision system controller 122VC is configured to characterize a planar surface PS of the front face (of the extracted object), and orientation of the planar surface PS relative to a predetermined reference frame (such as the autonomous guided vehicle reference frame BREF and/or global reference frame GREF). Again, referring to case CU2 as an example, the vision system controller 122VC characterizes, from the planar estimation of the matching stereo keypoints (Block 1040), the planar surface PS of the case face CF of case CU2 and determines the orientation (e.g., skew or yaw YW—see also FIG. 3A) of the planar surface PS relative to one or more of the global reference frame GREF and the autonomous guided vehicle reference frame BREF. The vision system controller 122VC is configured to characterize, from the planar estimation of the matching stereo keypoints (Block 1040), a pick surface BE (e.g., the bottom edge that defines the pick surface location, see FIG. 4A, of a case unit CU to be picked) of the extracted object (such as a case unit CU) based on characteristics of the planar surface PS, where the pick surface BE interfaces the payload handler or transfer arm 210A (see FIGS. 2 and 3A) of the autonomous guided vehicle 110.

As described above, the determination of the planar estimation of the matching stereo keypoints (Block 1040) includes points that are disposed a predetermined distance in front of the plane/surface formed by the matched stereo keypoints KP1-KP12. Here, the vision system controller 122VC is configured to resolve, from the planar estimation of the matching stereo keypoints, presence and characteristics of an anomaly (e.g., such as tape on the case face CF (see FIG. 6), an open case flap (see FIG. 6), a tear in the case face, etc.) to the planar surface PS.

The vision system controller 122VC is configured to generate at least one of an execute command and a stop command of an actuator (e.g., transfer arm 210A actuator, drive wheel 260 actuator, or any other suitable actuator of the autonomous guided vehicle 110) of the autonomous guided vehicle 110 based on the identified location and pose of a case CU to be picked. For example, where the case pose and location identify that the case CU to be picked is hanging off a shelf 555, such that the case cannot be picked substantially without interference or obstruction (e.g., substantially without error), the vision system controller 122VC may generate a stop command that prevents extension of the transfer arm 210A. As another example, where the case pose and location identify that the case CU to be picked is skewed and not aligned with the transfer arm 210A, the vision system controller 122VC may generate an execute command that effects traverse of the autonomous guided vehicle along a traverse surface to position the transfer arm 210A relative to the case CU to be picked so that the skewed case is aligned with the transfer arm 210A and can be picked without error.

It is noted that converse or corollary to the robust resolution of the case CU pose and location to either or both of the autonomous guided vehicle reference frame BREF and the global reference frame GREF, the resolution of the reference frame BREF of the autonomous guided vehicle 110 (e.g., pose and location) to the global reference frame GREF is available and can be resolved with the three-dimensional imaging system 440A, 440B (see FIG. 3A). For example, the three-dimensional imaging system 440A, 440B may be employed to detect a global reference datum (e.g., a portion of the storage and retrieval system structure having a known location, such as a calibration station described herein, a case transfer station, etc.), where the vision system controller 122VC determines the pose and location of the autonomous guided vehicle 110 relative to the global reference datum. The determination of the autonomous guided vehicle 110 pose and location and the pose and location of the case CU informs the controller 122 as to whether a pick/place operation can occur substantially without interference or obstruction.

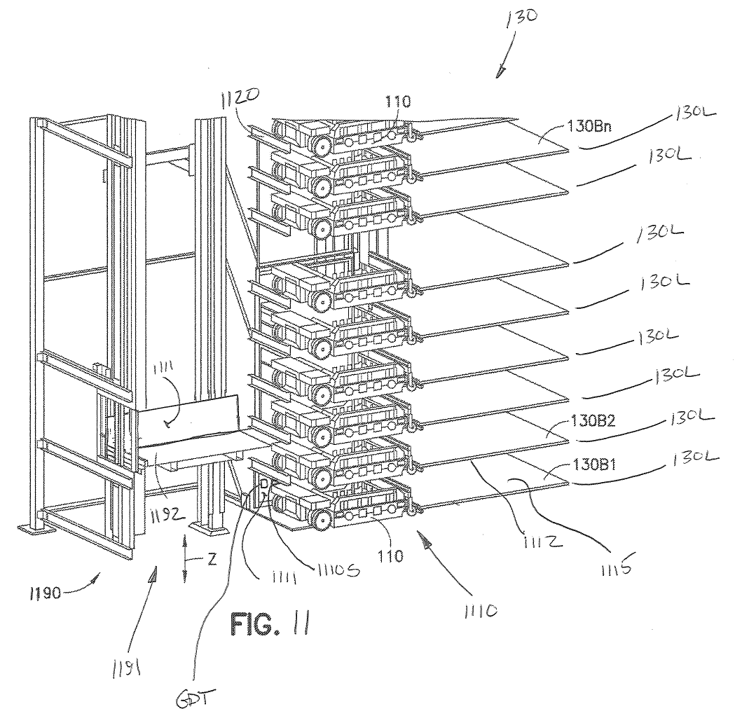

Referring to FIGS. 1A, 2, 3A, 3B, and 11, to obtain the video stream data imaging with the vision system 400, the stereo pairs of cameras 410A and 410B, 420A and 420B, 430A and 430B, 460A and 460B, 477A and 477B are calibrated. The stereo pairs of cameras 410A and 410B, 420A and 420B, 430A and 430B, 460A and 460B, 477A and 477B may be calibrated in any suitable manner (such as by, e.g., an intrinsic and extrinsic camera calibration) to effect sensing of case units CU, storage structure (e.g., shelves, columns, etc.), and other structural features of the storage and retrieval system. The calibration of the stereo pairs of cameras may be provided at a calibration station 1110 of the storage structure 130. As can be seen in FIG. 11, the calibration station 1110 may be disposed at or adjacent an autonomous guided vehicle ingress or egress location 1190 of the storage structure 130. The autonomous guided vehicle ingress or egress location 1190 provides for induction and removal of autonomous guided vehicles 110 to the one or more storage levels 130L of the storage structure 130 in a manner substantially similar to that described in U.S. Pat. No. 9,656,803 issued on May 23, 2017 and titled “Storage and Retrieval System Rover Interface,” the disclosure of which is incorporated herein by reference in its entirety. For example, the autonomous guided vehicle ingress or egress location 1190 includes a lift module 1191 so that entry and exit of the autonomous guided vehicles 110 may be provided at each storage level 130L of the storage structure 130. The lift module 1191 can be interfaced with the transfer deck 130B of one or more storage level 130L. The interface between the lift module 1191 and the transfer decks 130B may be disposed at a predetermined location of the transfer decks 130B so that the input and exit of autonomous guided vehicles 110 to each transfer deck 130B is substantially decoupled from throughput of the automated storage and retrieval system 100 (e.g. the input and output of the autonomous guided vehicles 110 at each transfer deck does not affect throughput). In one aspect the lift module 1191 may interface with a spur or staging area 130B1-130Bn (e.g. autonomous guided vehicles loading platform) that is connected to or forms part of the transfer deck 130B for each storage level 130L. In other aspects, the lift modules 1191 may interface substantially directly with the transfer decks 130B. It is noted that the transfer deck 130B and/or staging area 130B1-130Bn may include any suitable barrier 1120 that substantially prevents an autonomous guided vehicle 110 from traveling off the transfer deck 130B and/or staging area 130B1-130Bn at the lift module interface. In one aspect the barrier may be a movable barrier 1120 that may be movable between a deployed position for substantially preventing the autonomous guided vehicles 110 from traveling off of the transfer deck 130B and/or staging area 130B1-130Bn and a retracted position for allowing the autonomous guided vehicles 110 to transit between a lift platform 1192 of the lift module 1191 and the transfer deck 130B and/or staging area 130B1-130Bn. In addition to inputting or removing autonomous guided vehicles 110 to and from the storage structure 130, in one aspect, the lift module 1191 may also transport rovers 110 between storage levels 130L without removing the autonomous guided vehicles 110 from the storage structure 130.

Each of the staging areas 130B1-130Bn includes a respective calibration station 1110 that is disposed so that autonomous guided vehicles 110 may repeatedly calibrate the stereo pairs of cameras 410A and 410B, 420A and 420B, 430A and 430B, 460A and 460B, 477A and 477B. The calibration of the stereo pairs of cameras may be automatic upon autonomous guided vehicle registration (via the autonomous guided vehicle ingress or egress location 1190 in a manner substantially similar to that described in U.S. Pat. No. 9,656,803, previously incorporated by reference) into the storage structure 130. In other aspects, the calibration of the stereo pairs of cameras may be manual (such as where the calibration station is located on the lift 1192) and be performed prior to insertion of the autonomous guided vehicle 110 into the storage structure 130 in a manner similar to that described herein with respect to calibration station 1110.

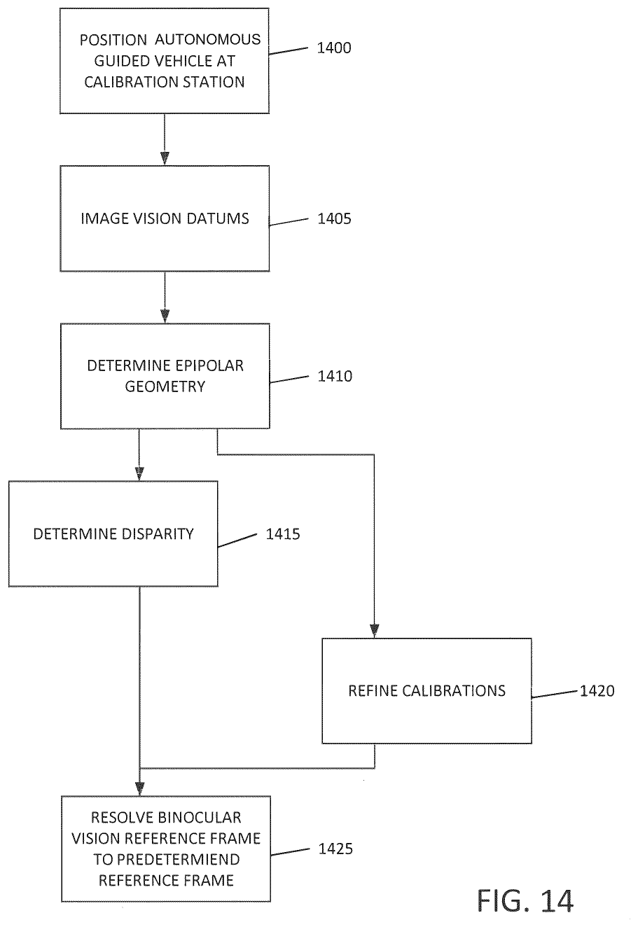

To calibrate the stereo pairs of cameras the autonomous guided vehicle is positioned (either manually or automatically) at a predetermined location of the calibration station 1110 (FIG. 14, Block 1400). Automatic positioning of the autonomous guided vehicle 110 at the predetermined location may employ detection of any suitable features of the calibration station 1110 with the vision system 400 of the autonomous guided vehicle 110. For example, the calibration station 1110 includes any suitable location flags or positions 1110S disposed on one or more surfaces 1200 of the calibration station 1110. The location flags 1110S are disposed on the one or more surfaces within the fields of view of at least one camera 410A, 410B of a respective camera pair. The vision system controller 122VC is configured to detect the location flags 1110S, and with detection of one or more of the location flags 1110S, the autonomous guided vehicle is grossly located relative to the calibration or known objects 1210-1218 of the calibration station 1110. In other aspects, in addition to or in lieu of the location flags 1110S, the calibration station 1110 may include a buffer or physical stop against which the autonomous guided vehicle 110 abuts for locating itself at the predetermined location of the calibration station 1110. The buffer or physical stop may be, for example, the barrier 1120 or any other suitable stationary or deployable feature of the calibration station. Automatic positioning of the autonomous guided vehicle 110 in the calibration station 1110 may be effected as the autonomous guided vehicle 110 is inducted into the storage and retrieval system 100 (such as with the autonomous guided vehicle exiting the lift 1192) and/or any suitable time where the autonomous guided vehicle enters the calibration station 1110 from the transfer deck 130. Here, the autonomous guided vehicle 110 may be programmed with calibration instructions that effect stereo vision calibration upon induction into the storage structure 130 or the calibration instructions may be initialized at any suitable time with the autonomous guided vehicle 110 operating (i.e., in service) within the storage structure 130.

One or more surfaces 1200 of each calibration station 1110 includes any suitable number of known objects 1210-1218. The one or more surfaces 1200 may be any surface that is viewable by the stereo pairs of cameras including, but not limited to, a side wall 1111 of the calibration station 1110, a ceiling 1112 of the calibration station 1110, a floor/traverse surface 1115 of the calibration station 1110, and a barrier 1120 of the calibration station 1110. The objects 1210-1218 (also referred to as vision datums or calibration objects) included with a respective surface 1200 may be raised structures, apertures, appliques (e.g., paint, stickers, etc.) that each have known physical characteristics such as shape, size, etc.

Calibration of case unit monitoring (stereo image) cameras 410A, 410B using the calibration station 1110 will be described for exemplary purposes and it should be understood that the other stereo image cameras may be calibrated in a substantially similar manner. With an autonomous guided vehicle 110 remaining persistently stationary at the predetermined location of the calibration station 1110 (at a location in which the objects 1210-1218 are within the fields of view of the cameras 410A, 410B) throughout the calibration process, each camera 410A, 410B of the stereo image cameras images the objects 1210-1218 (FIG. 14, Block 1405). These images of the objects are registered by the vision system controller 122VC (or controller 122), where the vision system controller 122VC is configured to calibrate the stereo vision of the stereo image cameras by determining epipolar geometry of the camera pair (FIG. 14, Block 1410) in any suitable manner (such as described in Wheeled Mobile Robotics from Fundamentals Towards Autonomous Systems, 1^{st} Ed., 2017, ISBN 9780128042045, the disclosure of which are incorporated herein by reference in their entireties). The vision system controller 122VC is also configured to calibrate the disparity between the cameras 410A, 410B in the stereo camera using the objects 1210-1218 where the disparity between the cameras 410A, 410B is determined (FIG. 14, Block 1415) by matching pixels from an image taken by camera 410A with pixels in a corresponding image taken by camera 410B and a distance for each pair of matching pixels is computed. The calibrations for disparity and epipolar geometry may be further refined (FIG. 14, Block 1420) in any suitable manner with, for example, data obtained from images of the objects 1210-1218 taken with the three-dimensional imaging system 440A, 440B of the autonomous guided vehicle 110.

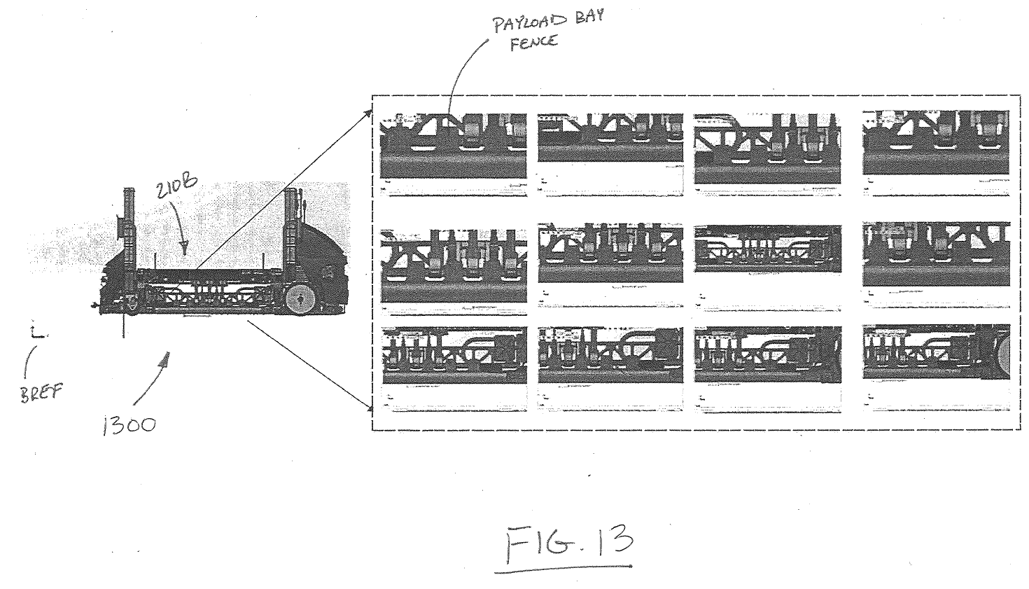

Further, the binocular vision reference frame may be transformed or otherwise resolved to a predetermined reference frame (FIG. 14, Block 1425) such as the autonomous guided vehicle 110 reference frame BREF and/or the global reference frame GREF using the three-dimensional imaging system 440A, 440B, where a portion of the autonomous guided vehicle 110 (such as a portion of frame 200 with known dimensions or transfer arm 210A in a known pose with respect to the frame 200) is imaged relative to a known global reference frame datum (e.g., such as a global datum target GDT disposed at the calibration station 1110, which in some aspects may be the same as the objects 1210-1218). As may be realized, referring also to FIG. 13, to translate the binocular vision reference frame of the respective camera pairs to the reference frame BREF of the autonomous guided vehicle 110 or the global reference frame GREF of the storage structure 130, a computer model 1300 (such as a computer aided drafting or CAD model) of the autonomous guided vehicle 110 (and/or a computer model 400VM (see FIG. 1A) of the operating environment of the storage structure 130 may also be employed by the vision system controller 122VC. As can be seen in FIG. 13, feature dimensions, such as of any suitable features of the payload bed 210B depending on which camera pair is being calibrated (which in this example are features of the payload bed fence relative to the reference frame BREF or any other suitable features of the autonomous guided vehicle 110 via the autonomous guided vehicle model 1300 and/or suitable features of the storage structure via the virtual model 400VM of the operating environment), may be extracted by the vision system controller 122VC for portions of the autonomous guided vehicle 110 within the fields of view of the camera pairs. These feature dimensions of the payload bed 210B are determined from an origin of the reference frame BREF of the autonomous guided vehicle 110. These known dimensions of the autonomous guided vehicle 110 are employed by the vision system controller 122VC along with the image pairs or disparity map created by the stereo image cameras to correlate the reference frame of each camera (or the reference frame of the camera pair) to the reference frame BREF of the autonomous guided vehicle 110. Similarly, feature dimensions of the global datum target GDT are determined from an origin (e.g., of the global reference frame GREF) of the storage structure 130. These known dimensions of the global datum target GDT are employed by the vision system controller 122VC along with the image pairs or disparity map created by the stereo image cameras to correlate the reference frame of each camera (the stereo vision reference frame) to the global reference frame GREF.

Where the calibration of the stereo vision of the autonomous guided vehicle 110 is manually effected, the autonomous transport vehicle 110 is manually positioned at the calibration station. For example, the autonomous guided vehicle 110 is manually positioned on the lift 1191 which includes surface(s) 1111 (one of which is shown, while others may be disposed at ends of the lift platform or disposed above the lift platform in orientations similar to the surfaces of the calibration stations 1110 (e.g., the lift platform is configured as a calibration station). The surface(s) include the known objects 1210-1218 and/or global datum target GDT such that calibration of the stereo vision occurs in a manner substantially similar to that described above.

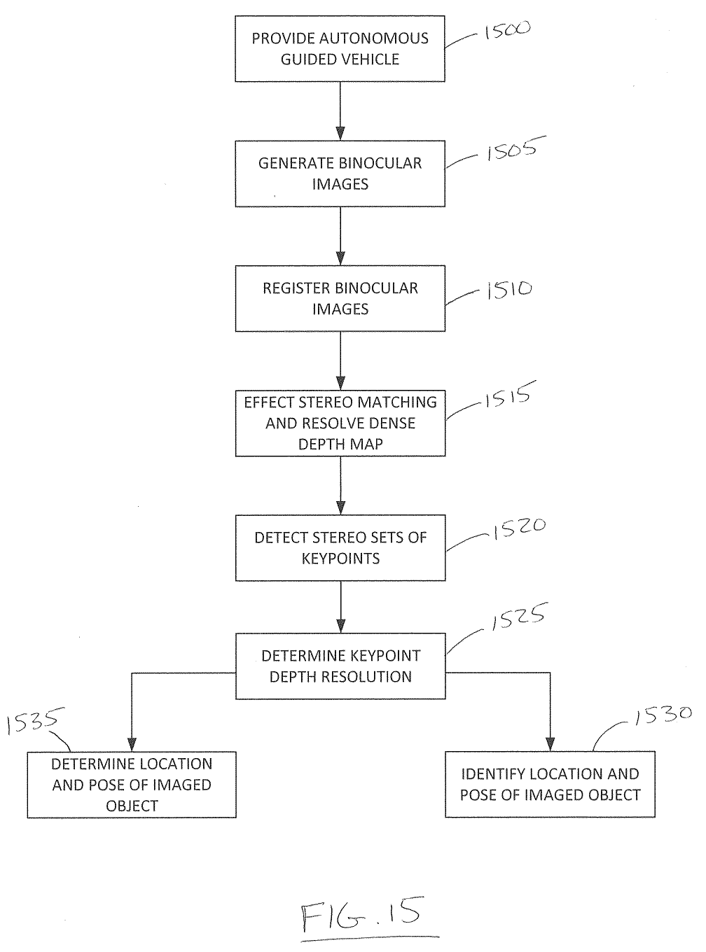

Referring to FIGS. 1A, 2, 3A, 3B, 6, and 7 and exemplary method, for determining a pose and location of an imaged object, in accordance with the aspects of the disclosed embodiment will be described. In the method, the autonomous guided vehicle 110 described herein is provided (FIG. 15, Block 1500). The vision system 400 generates binocular images 600A, 600B (FIG. 15, Block 1505) of a field (that is defined by the combined fields of view of the cameras in the pair of cameras, such as cameras 410A and 410B—see FIGS. 6 and 7) of the logistic space (e.g., formed by the storage structure 130) including rack structure shelving 555 on which more than one objects (such as case units CU) are stored. The controller (such as vision system controller 122VC or controller 122), that is communicably connected to the vision system 400, registers (such as in any suitable memory of the controller) the binocular images 600A, 600B (FIG. 15, Block 1510), and effects stereo matching, from the binocular images, resolving the dense depth map 620 (FIG. 15, Block 1515) of imaged objects in the field. The controller detects, from the binocular images, stereo sets of keypoints KP1-KP12 (FIG. 15, Block 1520), each set of keypoints (each image 600A, 600B having a set of keypoints) setting out, separate and distinct from each other set, a common predetermined characteristic of each imaged object, so that the controller determines from the stereo sets of keypoints KP1-KP12 depth resolution (FIG. 15, Block 1525) of each object separate and distinct from the dense depth map 620. The controller determines or identifies, with an object extractor 1000 of the controller, location and pose of each imaged object (FIG. 15, Blocks 1530 and 1535) from both the dense depth map 620 resolved from the binocular images 600A, 600B and the depth resolution from the stereo sets of keypoints KP1-KP12.

In accordance with one or more aspects of the disclosed embodiment, an autonomous guided vehicle is provided. The autonomous guided vehicle includes a frame with a payload hold; a drive section coupled to the frame with drive wheels supporting the autonomous guided vehicle on a traverse surface, the drive wheels effect vehicle traverse on the traverse surface moving the autonomous guided vehicle over the traverse surface in a facility; a payload handler coupled to the frame configured to transfer a payload, with a flat undeterministic seating surface seated in the payload hold, to and from the payload hold of the autonomous guided vehicle and a storage location, of the payload, in a storage array; a vision system mounted to the frame, having more than one camera disposed to generate binocular images of a field of a logistic space including rack structure shelving on which more than one objects are stored; and a controller, communicably connected to the vision system so as to register the binocular images, and configured to effect stereo matching, from the binocular images, resolving a dense depth map of imaged objects in the field, and the controller is configured to detect from the binocular images, stereo sets of keypoints, each set of keypoints setting out, separate and distinct from each other set, a common predetermined characteristic of each imaged object, so that the controller determines from the stereo sets of keypoints depth resolution of each object separate and distinct from the dense depth map; wherein the controller has an object extractor configured to determine location and pose of each imaged object from both the dense depth map resolved from the binocular images and the depth resolution from the stereo sets of keypoints.

In accordance with one or more aspects of the disclosed embodiment, the more than one camera are rolling shutter cameras.

In accordance with one or more aspects of the disclosed embodiment, the more than one camera generate a video stream and the registered images are parsed from the video stream.

In accordance with one or more aspects of the disclosed embodiment, the more than one camera are unsynchronized with each other.

In accordance with one or more aspects of the disclosed embodiment, the binocular images are generated with the vehicle in motion past the objects.

In accordance with one or more aspects of the disclosed embodiment, the more than one objects on the racks structure are dynamically positioned in closely packed juxtaposition with respect to each other.

In accordance with one or more aspects of the disclosed embodiment, the controller is configured to determine a front face, of at least one extracted object, and dimensions of the front face.

In accordance with one or more aspects of the disclosed embodiment, the controller is configured to characterize a planar surface of the front face, and orientation of the planar surface relative to a predetermined reference frame.

In accordance with one or more aspects of the disclosed embodiment, the controller is configured to characterize a pick surface, of the extracted object based on characteristics of the planar surface, that interfaces the payload handler.

In accordance with one or more aspects of the disclosed embodiment, the controller is configured to resolve presence and characteristics of an anomaly to the planar surface.

In accordance with one or more aspects of the disclosed embodiment, the controller is configured to determine a logistic identity of the extracted object based on dimensions of the front face.

In accordance with one or more aspects of the disclosed embodiment, the controller is configured to generate at least one of an execute command and a stop command of a bot actuator based on the determined location and pose.

In accordance with one or more aspects of the disclosed embodiment, an autonomous guided vehicle is provided. The autonomous guided vehicle includes a frame with a payload hold; a drive section coupled to the frame with drive wheels supporting the autonomous guided vehicle on a traverse surface, the drive wheels effect vehicle traverse on the traverse surface moving the autonomous guided vehicle over the traverse surface in a facility; a payload handler coupled to the frame configured to transfer a payload, with a flat undeterministic seating surface seated in the payload hold, to and from the payload hold of the autonomous guided vehicle and a storage location, of the payload, in a storage array; a vision system mounted to the frame, having binocular imaging cameras generating binocular images of a field of a logistic space including rack structure shelving on which more than one objects are stored; and a controller, communicably connected to the vision system so as to register the binocular images, and configured to effect stereo matching, from the binocular images, resolving a dense depth map of imaged objects in the field, and the controller is configured to detect from the binocular images, stereo sets of keypoints, each set of keypoints setting out, separate and distinct from each other set of keypoints, a common predetermined characteristic of each imaged object, so that the controller determines from the stereo sets of keypoints depth resolution of each object separate and distinct from the dense depth map; wherein the controller has an object extractor configured to identify location and pose of each imaged object based on superpose of stereo sets of keypoints depth resolution and depth map.

In accordance with one or more aspects of the disclosed embodiment, the more than one camera are rolling shutter cameras.

In accordance with one or more aspects of the disclosed embodiment, the more than one camera generate a video stream and the registered images are parsed from the video stream.

In accordance with one or more aspects of the disclosed embodiment, the more than one camera are unsynchronized with each other.

In accordance with one or more aspects of the disclosed embodiment, the binocular images are generated with the vehicle in motion past the objects.

In accordance with one or more aspects of the disclosed embodiment, the more than one objects on the racks structure are dynamically positioned in closely packed juxtaposition with respect to each other.

In accordance with one or more aspects of the disclosed embodiment, the controller is configured to determine a front face, of at least one extracted object, and dimensions of the front face.

In accordance with one or more aspects of the disclosed embodiment, the controller is configured to characterize a planar surface of the front face, and orientation of the planar surface relative to a predetermined reference frame.

In accordance with one or more aspects of the disclosed embodiment, the controller is configured to characterize a pick surface, of the extracted object based on characteristics of the planar surface, that interfaces the payload handler.

In accordance with one or more aspects of the disclosed embodiment, the controller is configured to resolve presence and characteristics of an anomaly to the planar surface.

In accordance with one or more aspects of the disclosed embodiment, the controller is configured to determine a logistic identity of the extracted object based on dimensions of the front face.

In accordance with one or more aspects of the disclosed embodiment, the controller is configured to generate at least one of an execute command and a stop command of a bot actuator based on the identified location and pose.

In accordance with one or more aspects of the disclosed embodiment, a method is provided. The method includes providing an autonomous guided vehicle including: a frame with a payload hold, a drive section coupled to the frame with drive wheels supporting the autonomous guided vehicle on a traverse surface, the drive wheels effect vehicle traverse on the traverse surface moving the autonomous guided vehicle over the traverse surface in a facility, and a payload handler coupled to the frame configured to transfer a payload, with a flat undeterministic seating surface seated in the payload hold, to and from the payload hold of the autonomous guided vehicle and a storage location, of the payload, in a storage array; generating, with a vision system mounted to the frame and having more than one camera, binocular images of a field of a logistic space including rack structure shelving on which more than one objects are stored; registering, with a controller that is communicably connected to the vision system, the binocular images, and effecting stereo matching, from the binocular images, resolving a dense depth map of imaged objects in the field; detecting from the binocular images, with the controller, stereo sets of keypoints, each set of keypoints setting out, separate and distinct from each other set, a common predetermined characteristic of each imaged object, so that the controller determines from the stereo sets of keypoints depth resolution of each object separate and distinct from the dense depth map; and determining, with an object extractor of the controller, location and pose of each imaged object from both the dense depth map resolved from the binocular images and the depth resolution from the stereo sets of keypoints.

In accordance with one or more aspects of the disclosed embodiment, the more than one camera are rolling shutter cameras.

In accordance with one or more aspects of the disclosed embodiment, the method further includes parsing the registered images from a video stream generated by the more than one camera.

In accordance with one or more aspects of the disclosed embodiment, the more than one camera are unsynchronized with each other.

In accordance with one or more aspects of the disclosed embodiment, the method further includes generating the binocular images with the vehicle in motion past the objects.

In accordance with one or more aspects of the disclosed embodiment, the more than one objects on the racks structure are dynamically positioned in closely packed juxtaposition with respect to each other.

In accordance with one or more aspects of the disclosed embodiment, the method further includes determining, with the controller, a front face of at least one extracted object, and dimensions of the front face.

In accordance with one or more aspects of the disclosed embodiment, the method further includes characterizing, with the controller, a planar surface of the front face, and orientation of the planar surface relative to a predetermined reference frame.

In accordance with one or more aspects of the disclosed embodiment, the method further includes, characterizing, with the controller, a pick surface, of the extracted object based on characteristics of the planar surface, that interfaces the payload handler.

In accordance with one or more aspects of the disclosed embodiment, the method further includes resolving, with the controller, presence and characteristics of an anomaly to the planar surface.

In accordance with one or more aspects of the disclosed embodiment, the method further includes determining, with the controller, a logistic identity of the extracted object based on dimensions of the front face.

In accordance with one or more aspects of the disclosed embodiment, the method further includes generating, with the controller, at least one of an execute command and a stop command of a bot actuator based on the determined location and pose.

In accordance with one or more aspects of the disclosed embodiment, a method is provided. The method includes providing an autonomous guided vehicle including: a frame with a payload hold, a drive section coupled to the frame with drive wheels supporting the autonomous guided vehicle on a traverse surface, the drive wheels effect vehicle traverse on the traverse surface moving the autonomous guided vehicle over the traverse surface in a facility, and a payload handler coupled to the frame configured to transfer a payload, with a flat undeterministic seating surface seated in the payload hold, to and from the payload hold of the autonomous guided vehicle and a storage location, of the payload, in a storage array; generating, with a vision system having binocular imaging cameras, binocular images of a field of a logistic space including rack structure shelving on which more than one objects are stored; registering, with a controller communicably connected to the vision system, the binocular images, and effecting, with the controller, stereo matching, from the binocular images, resolving a dense depth map of imaged objects in the field; detecting from the binocular images, with the controller, stereo sets of keypoints, each set of keypoints setting out, separate and distinct from each other set, a common predetermined characteristic of each imaged object, so that the controller determines from the stereo sets of keypoints depth resolution of each object separate and distinct from the dense depth map; and identifying, with an object extractor of the controller, location and pose of each imaged object based on superpose of stereo sets of keypoints depth resolution and depth map.

In accordance with one or more aspects of the disclosed embodiment, the more than one camera are rolling shutter cameras.

In accordance with one or more aspects of the disclosed embodiment, the method further includes parsing the registered images from a video stream generated by the more than one camera.

In accordance with one or more aspects of the disclosed embodiment, the more than one camera are unsynchronized with each other.

In accordance with one or more aspects of the disclosed embodiment, the method further includes generating the binocular images with the vehicle in motion past the objects.

In accordance with one or more aspects of the disclosed embodiment, the more than one objects on the racks structure are dynamically positioned in closely packed juxtaposition with respect to each other.

In accordance with one or more aspects of the disclosed embodiment, the method further includes determining, with the controller, a front face of at least one extracted object, and dimensions of the front face.

In accordance with one or more aspects of the disclosed embodiment, the method further includes characterizing, with the controller, a planar surface of the front face, and orientation of the planar surface relative to a predetermined reference frame.

In accordance with one or more aspects of the disclosed embodiment, the method further includes characterizing, with the controller, a pick surface, of the extracted object based on characteristics of the planar surface, that interfaces the payload handler.

In accordance with one or more aspects of the disclosed embodiment, the method further including resolving, with the controller, presence and characteristics of an anomaly to the planar surface.

In accordance with one or more aspects of the disclosed embodiment, the method further including determining, with the controller, a logistic identity of the extracted object based on dimensions of the front face.

In accordance with one or more aspects of the disclosed embodiment, the method further including generating, with the controller, at least one of an execute command and a stop command of a bot actuator based on the identified location and pose.

APPENDIX A

| Stereo Method | Reference |
|---|---|
| RDNet | Xiaowei Yang, Zhiguo Feng, Yong Zhao, Guiying Zhang, and Lin He. Edge |
| | supervision and multi-scale cost volume for stereo matching. Image and Vision |
| | Computing, Volume 117, January 2022, 104336. |
| CRMV2 | Xiao Guo. Cost volume refine module v2. Submitted to SPL, 2022. |
| ACT | Madiha Zahari. A new cost volume estimation using modified CT. Submitted to the |
| | Bulletin of Electrical Engineering and Informatics (BEEI), paper ID 4122, 2022. |
| EAI-Stereo | Anonymous. EAI-Stereo: Error aware iterative network for stereo matching. ACCV |
| | 2022 submission 66. |
| LSMSW | Chao He. Local stereo matching with side window. Submitted to IEEE Signal |
| | Processing Letters, 2022. |
| Z2ZNCC | Qiong Chang et al. Efficient stereo matching on embedded GPUs with zero-means |
| | cross correlation. Journal of Systems Architecture, 2022. |
| AANet_Edge | Anonymous. Depth-based optimization for accurate stereo matching. ECCV 2022 |
| | submission 100. |
| MSTR | Anonymous. Context enhanced stereo transformer. ECCV 2022 submission 2649. |
| UPFNet | Anonymous. Unambiguous pyramid cost volumes fusion for stereo matching. CVPR |
| | 2022 submission 8565. |
| Gwc_CoAtRS | Junda Cheng and Gangwei Xu. CoAtRS stereo: Fully exploiting convolution and |
| | attention for stereo matching. Submitted to IEEE Transactions on Multimedia, 2021. |
| FENet | Shenglun Chen. Feature enhancement stereo matching network. Submitted to IEEE |
| | TCSVT 2021. |
| CREStereo | Anonymous. Practical stereo matching via cascaded recurrent network with adaptive |
| | correlation. CVPR 2022 submission 6512. |
| SWFSM | Chao He, Ming Li, and Congxuan Zhang. Side window filtering for stereo matching. |
| | Submitted to Electronics Letters, 2021. |
| ACVNet | Anonymous. Attention cost volume network for stereo. CVPR 2022 submission 8391. |
| GANet-RSSM | Anonymous. Region separable stereo matching. 3DV 2021 submission 110. |
| MMStereo | Krishna Shankar, Mark Tjersland, Jeremy Ma, Kevin Stone, and Max Bajracharya. A |
| | learned stereo depth system for robotic manipulation in homes. ICRA 2022 submission. |
| SDCO | Xianjing Cheng and Yong Zhao. Segment-based disparity computation with occlusion |
| | handling for accurate stereo matching. Submitted to IEEE TCSVT, 2021. |
| DSFCA | Kai Zeng. Deep stereo matching with superpixel based feature and cost aggregation. |
| | Submitted to IEEE TCVST, 2021. |
| DMCA-RVC | Kai Zeng. DMCA stereo network. Submitted to TPAMI, 2021. |
| RAFT-Stereo | Lahav Lipson, Zachary Teed, and Jia Deng. RAFT-Stereo: Multilevel recurrent field |
| | transforms for stereo matching. 3DV 2021. Code. |
| HBP ISP | Tingman Yan and Qunfei Zhao. Hierarchical belief propagation on image segmentation |
| | pyramid. Submitted to IEEE TIP, 2021. |
| MFN_USFDSRVC | Zhengyu Huang, Theodore Norris, and Panqu Wang. ES-Net: An efficient stereo |
| | matching network. arXiv: 2103.03922, 2021. |
| ERW-LocalExp | Anonymous. Estimate regularization weight for local expansion moves stereo matching. |
| | ACPR 2021 submission. |
| R3DCNN | Anonymous. Deep learning based stereo cost aggregation on a small dataset. DICTA |
| | 2021 submission. |
| ReS2tAC | Boitumelo Ruf, Jonas Mohrs, Martin Weinmann, Stefan Hinz, and Jürgen Beyerer. |
| | ReS2tAC-UAV-borne real-time SGM stereo optimized for embedded ARM and |
| | CUDA devices. MDPI Sensors 21(11), 2021. |
| FADNet++ | Anonymous. FADNet++: Real-time disparity estimation by configurable network |
| | structure. ICLR 2022 submission ???. |
| RANet++ | Anonymous. RANet++: Cost volume and correlation based network for efficient stereo |
| | matching. ICRA 2021 submission. |
| FADNet_RVC | Qiang Wang, Shaohuai Shi, Shizhen Zheng, Kaiyong Zhao, and Xiaowen Chu. |
| | FADNet: A fast and accurate network for disparity estimation. ICRA 2020. Code. |
| ADSG | Hao Liu, Hanlong Zhang, Xiaoxi Nie, Wei He, Dong Luo, Guohua Jiao and Wei Chen. |
| | Stereo matching algorithm based on two-phase adaptive optimization of AD-census and |
| | gradient fusion. IEEE RCAR 2021. |
| LESC | Xianjing Cheng, Yong Zhao, Zhijun Hu, Xiaomin Yu, Ren Qian, and Haiwei Sang. |
| | Superpixel cut-based local expansion for accurate stereo matching. IET Image |
| | Processing, 2021. |
| LocalExp-RC | Anonymous. Local expansion moves for stereo matching based on RANSAC |
| | confidence. ICCV 2021 submission 3073. |
| ORStereo | Yaoyu Hu, Wenshan Wang, Huai Yu, Weikun Zhen, and Sebastian Scherer. |
| | ORStereo: Occlusion-aware recurrent stereo matching for 4K-resolution images. IROS |
| | 2021 submission 192. |
| ACR-GIF-OW | Lingyin Kong, Jiangping Zhu, and Sancong Ying. Local stereo matching using adaptive |
| | cross-region based guided image filtering with orthogonal weights. Submitted to |
| | Mathematical Problems in Engineering, 2020. |
| SLCCF | Peng Yao and Jieqing Feng. Stacking learning with coalesced cost filtering for accurate |
| | stereo matching. Submitted to Journal of Visual Communication and Image |
| | Representation 2020. |
| CooperativeStereo | Menglong Yang, Fangrui Wu, Wei Li, Peng Cheng, and Xuebin Lv. CooperativeStereo: |
| | Cooperative convolutional neural networks for stereo matching. Submitted to Pattern |
| | Recognition 2020. |
| LPSC | Xianjing Cheng and Yong Zhao. Local PatchMatch based on superpixel cut for efficient |
| | high-resolution stereo matching. Submitted to BABT (Brazilian Archives of Biology and |
| | Technology), 2021. |
| DecStereo | Anonymous. A decomposition model for stereo matching. CVPR submission 2543. |
| RASNet | Anonymous. Stereo matching by high-resolution correlation volume learning and |
| | epipolar lookup. CVPR 2021 submission 1654. |
| SSCasStereo | Anonymous. Semi-synthesis: a fast way to produce effective datasets for stereo |
| | matching. CVPR 2021 submission 3688. |
| UnDAF-GANet | Anonymous. UnDAF: A general unsupervised domain adaptation framework for |
| | disparity, optical flow or scene flow estimation. CVPR 2021 submission 236. |
| RLStereo | Anonymous. RLStereo: Real-time stereo matching based on reinforcement learning. |
| | CVPR 2021 submission 4443. |
| FC-DCNN | Dominik Hirner. FC-DCNN: A densely connected neural network for stereo estimation. |
| | ICPR 2020. |
| HITNet | Vladimir Tankovich, Christian Hane, Yinda Zhang, Adarsh Kowdle, Sean Fanello, and |
| | Sofien Bouaziz. HITNet: Hierarchical iterative tile refinement network for real- |
| | time stereo matching. CVPR 2021. |
| ACMC | Anonymous. Adaptive combined matching cost for depth map estimation. WACV 2010 |
| | submission 619. |
| AdaStereo | Xiao Song, Guorun Yang, Xinge Zhu, Hui Zhou, Zhe Wang, and Jianping Shi. |
| | AdaStereo: A simple and efficient approach for adaptive stereo matching. CVPR 2021. |
| LPSM | Chenglong Xu, Chengdong Wu, Daokui Qu, Haibo Sun and Jilai Song. Accurate and |
| | efficient stereo matching by log-angle and pyramid-tree. Submitted to IEEE TCSVT, |
| | 2020. |
| LE_PC | Haiwei Sang and Yong Zhao. A pixels based stereo matching algorithm using |
| | cooperative optimization. Submitted to IEEE Access, 2020 |
| STTRV1_RVC | Anonymous. STTR. RVC 2020 submission. |
| CFNet_RVC | Anonymous. Cascade and fuse cost volume for efficient and robust stereo matching. |
| | CVPR 2021 submission 1728. |
| NLCA_NET_v2_ | Zhibo Rao, Mingyi He, Yuchao Dai, Zhidong Zhu, Bo Li, and Renjie He. NLCA-Net: |
| RVC | A non-local context attention network for stereo matching. APSIPA Transactions on |
| | Signal and Information Processing, 2020. RVC 2020 submission. |
| CVANet_RVC | Haoyu Ren. Cost-volume attention network. RVC 2020 submission. |
| UCNet | Tianyu Pan and Yao Du. Cascaded pyramid stereo matching network. Submitted to |
| | Pattern Recognition 2020. |
| AANet RVC | Haofei Xu and Juyong Zhang. AANet: Adaptive aggregation network for efficient |
| | stereo matching. CVPR 2020. RVC 2020 submission. |
| GANetREF_RVC | GA-Net reference submission as baseline for RVC 2020. Original reference: Feihu |
| | Zhang, Victor Prisacariu, Ruigang Yang, and Philip Torr. GA-Net: Guided |
| | Aggregation Net for End-to-end Stereo Matching. CVPR 2019. |
| HLocalExp-CM | Xianjing Cheng and Yong Zhao. HLocalExp-CM: Confidence map by hierarchical |
| | local expansion moves for stereo matching. To appear in Journal of Electronic |
| | Imaging, 2022. |
| MANE | Hector Vazquez, Madain Perez, Abiel Aguilar, Miguel Arias, Marco Palacios, Antonio |
| | Perez, Jose Camas, and Sabino Trujillo. Real-time multi-window stereo matching |
| | algorithm with fuzzy logic. Submitted to IET Computer Vision, 2020. |
| RTSMNet | Yun Xie, Shaowu Zheng, and Weihua Li. Feature-guided spatial attention upsampling |
| | for real-time stereo matching. Submitted to IEEE MultiMedia, 2020. |
| LEAStereo | Anonymous. End-to-end neural architecture search for deep stereo matching. NeurIPS |
| | 2020 submission 4988. |
| CCNet | Mei Haocheng, Yu Lei, and Wang Tiankui. Class classification network for stereo |
| | matching. Submitted to The Visual Computer, 2020. |
| AANet++ | Haofei Xu and Juyong Zhang. AANet: Adaptive aggregation network for efficient |
| | stereo matching. CVPR 2020. |
| SUWNet | Haoyu Ren, Mostafa El-Khamy, and Jungwon Lee. Stereo disparity estimation via joint |
| | supervised, unsupervised, and weakly supervised learning. ICIP 2020. |
| SRM | James Okae, Juan Du, and Yueming Hu. Robust statistical approach to stereo disparity |
| | map denoising and refinement. Submitted to Journal of Control Theory and |
| | Technology, 2020. |
| MTS | Rafael Brandt, Nicola Strisciuglio, Nicolai Petkov, and Michael Wilkinson. Efficient |
| | binocular stereo correspondence matching with 1-D max-trees. Pattern Recognition |
| | Letters 2020. |
| SGBMP | Yaoyu Hu, Weikun Zhen, and Sebastian Scherer. Deep-learning assisted high- |
| | resolution binocular stereo depth reconstruction. ICRA 2020. |
| CRAR | Linghua Zeng and Xinmei Tian. CRAR: Accelerating stereo matching with cascaded |
| | regression and adaptive refinement. Submitted to Pattern Recognition, 2020. |
| CasStereo | Anonymous. Cascade cost volume for high-resolution multi-view stereo and stereo |
| | matching. CVPR 2020 submission 6312. |
| ADSR_GIF | Lingyin Kong, Jiangping Zhu, and Sancong Ying. Stereo matching based on guidance |
| | image and adaptive support region. Submitted to Acta Optica Sinica, 2020. |
| MTS2 | Rafael Brandt, Nicola Strisciuglio, and Nicolai Petkov. MTStereo 2.0: Improved |
| | accuracy of stereo depth estimation. ICPR 2020 submission. |
| PPEP-GF | Yuli Fu, Kaimin Lai, Weixiang Chen, and Youjun Xiang. A pixel pair based encoding |
| | pattern for stereo matching via an adaptively weighted cost. Submitted to IET Image |
| | Processing, 2020. |
| F-GDGIF | Weimin Yuan. Efficient local stereo matching algorithm based on fast gradient domain |
| | guided image filtering. Submitted to Pattern Recognition Letters, 2019. |
| CRLE | Huaiyuan Xu, Xiaodong Chen, Haitao Liang, Siyu Ren, and Haotian Li. Cross- based |
| | rolling label expansion for dense stereo matching. Submitted to IEEE Access, 2019. |
| SPPSMNet | Anonymous. Superpixel segmentation with fully convolutional networks. CVPR 2020 |
| | submission 8460. |
| HSM-Smooth-Occ | Anonymous. Enhancing deep stereo networks with geometric priors. CVPR 2020 |
| | submission 387. |
| SACA-Net | Anonymous. Scale-aware cost aggregation for stereo matching. CVPR 2020 submission |
| | 582. |
| LBPS | Patrick Knöbelreiter, Christian Sormann, Alexander Shekhovtsov, Friedrich |
| | Fraundorfer, and Thomas Pock. Belief propagation reloaded: Learning BP layers for |
| | dense prediction tasks. CVPR 2020. Code. |
| NVstereo2D | Anonymous. Deep stereo matching over 100 FPS. CVPR 2020 submission 8537. |
| EdgeStereo | Xiao Song, Xu Zhao, Liangji Fang, and Hanwen Hu. Edgestereo: An effective multi- |
| | task learning network for stereo matching and edge detection. To appear in IJCV 2019. |
| DeepPruner_ROB | Shivam Duggal, Shenlong Wang, Wei-Chiu Ma, Rui Hu, and Raquel Urtasun. |
| | DeepPruner: Learning efficient stereo matching via differentiable PatchMatch. ICCV |
| | 2019. Code. |
| PWCA_SGM | Hao Li, Yanwei Sun, and Li Sun. Edge-preserved disparity estimation with piecewise |
| | cost aggregation. Submitted to the International Journal of Geo-Information, 2019. |
| PSMNet_2000 | Wei Wang, Wei Bao, Yulan Guo, Siyu Hong, Zhengfa Liang, Xiaohu Zhang, and |
| | Yuhua Xu. An indoor real scene dataset to train convolution networks for stereo |
| | matching. Submitted to SCIENCE CHINA Information Sciences, 2019. |
| VN | Patrick Knöbelreiter and Thomas Pock. Learned collaborative stereo refinement. GCPR |
| | 2019. |
| tMGM-16 | Sonali Patil, Tanmay Prakash, Bharath Comandur, and Avinash Kak. A comparative |
| | evaluation of SGM variants for dense stereo matching. Submitted to PAMI, 2019. |
| TCSCSM | Chunbo Cheng, Hong Li, and Liming Zhang. A new stereo matching cost based on two- |
| | branch convolutional sparse coding and sparse representation. Submitted to IEEE TIP, |
| | 2019. |
| 3DMST-CM | Yuhao Xiao, Dingding Xu, Guijin Wang, Xiaowei Hu, Yongbing Zhang, Xiangyang Ji, |
| | and Li Zhang. Confidence map based 3D cost aggregation with multiple minimum |
| | spanning trees for stereo matching. ACPR 2019. |
| SM-AWP | Siti Safwana Abd Razak, Mohd Azlishah Othman, and Ahmad Fauzan Kadmin. The |
| | effect of adaptive weighted bilateral filter on stereo matching algorithm. International |
| | Journal of Engineering and Advanced Technology(IJEAT) 8(3) 2019, C5839028319. |
| DAWA-F | Julia Navarro and Antoni Buades. Dense and robust image registration by shift adapted |
| | weighted aggregation and variational completion. Submitted to Image and Vision |
| | Computing, 2019. |
| AMNet | Xianzhi Du, Mostafa El-Khamy, and Jungwon Lee. AMNet: Deep atrous multiscale |
| | stereo disparity estimation networks. arXiv: 1904.09099, 2019. |
| FASW | Wenhuan Wu, Hong Zhu, Shunyuan Yu, and Jing Shi. Stereo matching with fusing |
| | adaptive support weights. IEEE Access 7: 61960-61974, 2019. |
| EHCI_net | Run Wang. An end to end network for stereo matching using exploiting hierarchical |
| | context information. Master's thesis, HUST, 2019. |
| MCV-MFC | Zhengfa Liang, Yulan Guo, Yiliu Feng, Wei Chen, Linbo Qiao, Li Zhou, Jianfeng |
| | Zhang, and Hengzhu Liu. Stereo matching using multi-level cost volume and multi- |
| | scale feature constancy. PAMI 2019. |
| MSFNetA | Kyung-Rae Kim, Yeong Jun Koh, and Chang-Su Kim. Multiscale feature extractors |
| | for stereo matching cost computation. IEEE Access 6: 27971-27983, 2018. |
| MBM | Qiong Chang and Tsutomu Maruyama. Real-time stereo vision system: a multi- |
| | block matching on GPU. IEEE Access 6: 27971-27983, 2018. |
| HSM-Net_RVC | Gengshan Yang, Joshua Manela, Michael Happold, and Deva Ramanan. |
| | Hierarchical deep stereo matching on high-resolution images. CVPR 2019. Code. Also |
| | submitted to RVC 2020. |
| IEBIMst | Chao He, Congxuan Zhang, Zhen Chen, and Shaofeng Jiang. Minimum spanning |
| | tree based stereo matching using image edge and brightness information. CISP-BMEI |
| | 2017. |
| iResNet | Zhengfa Liang, Yiliu Feng, Yulan Guo, Hengzhu Liu, Wei Chen, Linbo Qiao, Li Zhou, |
| | and Jianfeng Zhang. Learning for disparity estimation through feature constancy. CVPR |
| | 2018. |
| Dense-CNN | Congxuan Zhang, Junjie Wu, Zhen Chen, Wen Liu, Ming Li, and Shaofeng Jiang. |
| | Dense-CNN: Dense convolutional neural network for stereo matching using multi- |
| | scale feature connection. Submitted to Signal Processing and Image Communication, |
| | 2019. |
| DISCO | Kunal Swami, Kaushik Raghavan, Nikhilanj Pelluri, Rituparna Sarkar, and Pankaj |
| | Bajpai. DISCO: Depth inference from stereo using context. ICME 2019. |
| MotionStereo | Julien Valentin, Adarsh Kowdle, Jonathan Barron, et al. Depth from motion for |
| | smartphone AR. ACM TOG 37(6): 193 (Proc. of SIGGRAPH Asia), 2018. |
| DCNN | Wendong Mao, Mingjie Wang, Jun Zhou, and Minglun Gong. Semi-dense stereo |
| | matching using dual CNNs. WACV 2019. |
| MSMD_ROB | Haihua Lu, Hai Xu, Li Zhang, Yanbo Ma, and Yong Zhao. Cascaded multi-scale and |
| | multi-dimension convolutional neural network for stereo matching. VCIP 2018. |
| CBMBNet | Yu Chen, Youshen Xia, and Chenwang Wu. A crop-based multi-branch network for |
| | matching cost computation. CISP-BMEI 2018. |
| CBMV_ROB | Konstantinos Batsos, Changjiang Cai, and Philippos Mordohai. CBMV: A coalesced |
| | bidirectional matching volume for disparity estimation. ROB 2018 entry based on |
| | CVPR 2018 paper. |
| iResNet_ROB | Zhengfa Liang, Yiliu Feng, Yulan Guo, Hengzhu Liu, Wei Chen, Linbo Qiao, Li Zhou, |
| | and Jianfeng Zhang. Learning for disparity estimation through feature constancy. ROB |
| | 2018 entry based on CVPR 2018 paper. |
| FBW_ROB | Benedikt Wiberg. Stereo matching with neural networks. Bachelors thesis, TU Munich |
| | 2018. ROB 2018 entry. |
| NOSS_ROB | Jie Li, Penglei Ji, and Xinguo Liu. Superpixel alpha-expansion and normal adjustment |
| | for stereo matching. Proceeding of CAD/Graphics 2019. |
| DN-CSS_ROB | Tonmoy Saikia, Eddy Ilg, and Thomas Brox. DispNet-CSS: Robust Vision submission. |
| | ROB 2018. |
| PDS | Stepan Tulyakov, Anton Ivanov, and Francois Fleuret. Practical deep stereo (PDS): |
| | Toward applications-friendly deep stereo matching. NeurIPS 2018. |
| PSMNet_ROB | Jia-Ren Chang and Yong-Sheng Chen. Pyramid stereo matching network. CVPR 2018. |
| | Code. ROB 2018 entry by Hisao Chien Yang. |
| ISM | Rostam Affendi Hamzah, Fauzan Kadmin, Saad Hamid, Fakhar Ghani, and Haidi |
| | Ibrahim. Improvement of stereo matching algorithm for 3D surface reconstruction. |
| | Signal Processing: Image Communication 65: 165-172, 2018. |
| ELAS_RVC | Andreas Geiger, Martin Roser, and Raquel Urtasun. Efficient large-scale stereo |
| | matching. ACCV 2010. Code. RVC 2020 baseline. |
| AVERAGE_ROB | Average disparity over all training images of the ROB 2018 stereo challenge. |
| MEDIAN_ROB | Median disparity over all training images of the ROB 2018 stereo challenge. |
| DTS | Akash Bapat and Jan-Michael Frahm. The domain transform solver. CVPR 2019. |
| SGM-Forest | Johannes Schönberger, Sudipta Sinha, and Marc Pollefeys. Learning to fuse |
| | proposals from multiple scanline optimizations in semi-global matching. ECCV 2018. |
| SGM_RVC | Heiko Hirschmüller. Stereo processing by semi-global matching and mutual |
| | information. CVPR 2006; PAMI 30(2): 328-341, 2008. RVC 2020 baseline. |
| SDR | Tingman Yan, Yangzhou Gan, Zeyang Xia, and Qunfei Zhao. Segment-based disparity |
| | refinement with occlusion handling for stereo matching. IEEE TIP 2019. Code. |
| DF | Wendong Mao and Minglun Gong. Disparity filtering with 3D convolutional neural |
| | networks. CRV 2018. |
| SMSSR | Hong Li and Chunbo Cheng. Adaptive weighted matching cost based on sparse |
| | representation. Submitted to IEEE TIP, 2018. |
| OVOD | Mikhail Mozerov and Joost van de Weijer. One-view-occlusion detection for stereo |
| | matching with a fully connected CRF model. IEEE TIP 28(6): 2936-2947, 2019. |
| | Code. |
| CBMV | Konstantinos Batsos, Changjiang Cai, and Philippos Mordohai. CBMV: A |
| | Coalesced bidirectional matching volume for disparity estimation. CVPR 2018. Code. |
| FEN-D2DRR | Xiaoqing Ye, Jiamao Li, Han Wang, Hexiao Huang, and Xiaolin Zhang. Efficient |
| | stereo matching leveraging deep local and context information. IEEE Access 5: 18745- |
| | 18755, 2017. |
| LocalExp | Tatsunori Taniai, Yasuyuki Matsushita, Yoichi Sato, and Takeshi Naemura. |
| | Continuous 3D label stereo matching using local expansion moves. PAMI 40(11): |
| | 2725-2739, 2018. Code. |
| DoGGuided | Masamichi Kitagawa, Ikuko Shimizu, and Radim Sara. High accuracy local stereo |
| | matching using DoG scale map. IAPR MVA 2017. |
| r200high | Leonid Keselman, John Woodfill, Anders Grunnet-Jepsen, and Achintya Bhowmik. |
| | Intel RealSense stereoscopic depth cameras. CVPR workshop CCD 2017. |
| DDL | Jihao Yin, Hongmei Zhu, Ding Yuan, and Tianfan Xue. Sparse representation over |
| | discriminative dictionary for stereo matching. Pattern Recognition 71: 278-289, 2017. |
| | Code |
| DSGCA | Williem and In Kyu Park. Deep self-guided cost aggregation for stereo matching. |
| | Pattern Recognition Letters 112: 168-175, 2018. |
| JMR | Patrick Knöbelreiter, Christian Reinbacher, Alexander Shekhovtsov, and Thomas Pock. |
| | End-to-end training of hybrid CNN-CRF models for stereo. CVPR 2017. |
| | Code. |
| MC-CNN+TDSR | Sebastien Drouyer, Serge Beucher, Michel Bilodeau, Maxime Moreaud, and Loic |
| | Sorbier. Sparse stereo disparity map densification using hierarchical image |
| | segmentation. 13th International Symposium on Mathematical Morphology, 2017. |
| SGMEPi | Daniel Scharstein, Tatsunori Taniai, and Sudipta Sinha. Semi-global stereo |
| | matching with surface orientation priors. 3DV 2017. |
| 3DMST | Lincheng Li, Xin Yu, Shunli Zhang, Xiaolin Zhao, and Li Zhang. 3D cost aggregation |
| | with multiple minimum spanning trees for stereo matching. Applied Optics 56(12): |
| | 3411-3420, 2017. |
| IGF | Rostam Affendi Hamzah, Haidi Ibrahim, and A. H. Abu Hassan. Stereo matching |
| | algorithm based on per pixel difference adjustment, iterative guided filter and graph |
| | segmentation. Journal of Visual Communication and Image Representation, 42: |
| | 145-160, 2017. |
| ADSM | Ning Ma, Yobo Men, Chaoguang Men, and Xiang Li. Accurate dense stereo |
| | matching based on image segmentation using an adaptive multi-cost approach. |
| | Symmetry 8(12): 159, 2016. |
| MCSC | Menglong Yang and Xuebin Lv. Learning both matching cost and smoothness |
| | constraint for stereo matching. Neurocomputing 314: 234-241, 2018. |
| MC-CNN-WS | Stepan Tulyakov, Anton Ivanov, and Francois Fleuret. Weakly supervised learning |
| | of deep metrics for stereo reconstruction. ICCV 2017. |
| SPS | Chloe LeGendre, Konstantinos Batsos, and Philippos Mordohai. High-resolution |
| | stereo matching based on sampled photoconsistency computation. BMVC 2017. |
| SIGMRF | Sonam Nahar and Manjunath Joshi. A learned sparseness and IGMRF-based |
| | regularization framework for dense disparity estimation using unsupervised feature |
| | learning. IPSJ CVA 9: 2, 2017. |
| LW-CNN | Haesol Park and Kyoung Mu Lee. Look wider to match image patches with |
| | convolutional neural network. IEEE Signal Processing Letters 24(12): 1788-1792, |
| | 2017. |
| SNP-RSM | Shuangli Zhang, Weijian Xie, Guofeng Zhang, Hujun Bao, and Michael Kaess. |
| | Robust stereo matching with surface normal prediction. ICRA 2017. |
| SED | Dexmont Pena and Alistair Sutherland. Disparity estimation by simultaneous edge |
| | drawing. ACCV 2016 Workshop on 3D modelling and applications. |
| LPU | Luis Horna and Robert Fisher. 3D plane labeling stereo matching with content |
| | aware adaptive windows. VISAPP 2017. |
| APAP-Stereo | Min-Gyu Park and Kuk-Jin Yoon. As-planar-as-possible depth map estimation. |
| | CVIU 181: 50-59, 2019. |
| PMSC | Lincheng Li, Shunli Zhang, Xin Yu, and Li Zhang. PMSC: PatchMatch-based |
| | superpixel cut for accurate stereo matching. IEEE TCSVT 28(3): 679-692, 2016. |
| JEM | Hongyang Xue and Deng Cai. Stereo matching by joint energy minimization. |
| | arXiv: 1601.03890, 2016. |
| HLSC_cor | Simon Hadfield, Karel Lebeda, and Richard Bowden. Stereo reconstruction using top- |
| | down cues. CVIU 157: 206-222, 2017. |
| ICSG | Mozhdeh Shahbazi, Gunho Sohn, Jerome Theau, and Patrick Menard. Revisiting |
| | intrinsic curves for efficient dense stereo matching. ISPRS Congress 2016. |
| MPSV | Jean-Charles Bricola, Michel Bilodeau, and Serge Beucher. Morphological |
| | processing of stereoscopic image superimpositions for disparity map estimation. HAL |
| | archives, hal-01330139f, 2016. |
| LS-ELAS | Radouane Ait-Jellal, Manuel Lange, Benjamin Wassermann, Andreas Schilling, and |
| | Andreas Zell. LS-ELAS: line segment based efficient large scale stereo matching. |
| | ICRA 2017. |
| MC-CNN-fst | Jure Zbontar and Yann LeCun. Stereo matching by training a convolutional neural |
| | network to compare image patches (fast architecture). JMER 17: 1-32, 2016. Code. |
| NTDE | Kyung-Rae Kim and Chang-Su Kim. Adaptive smoothness constraints for efficient |
| | stereo matching using texture and edge information. ICIP 2016. |
| INTS | Xu Huang, Yongjun Zhang, and Zhaoxi Yue. Image-guided non-local dense |
| | matching with three-steps optimization. ISPRS Congress 2016. |
| MC-CNN + RBS | Jonathan Barron and Ben Poole. The fast bilateral solver. ECCV 2016. Code. |
| MDP | Ang Li, Dapeng Chen, Yuanliu Liu, and Zejian Yuan. Coordinating multiple disparity |
| | proposals for stereo computation. CVPR 2016. |
| R-NCC | Yichao Li and Suping Fang. Removal-based multi-view stereo using a window- |
| | based matching method. Optik 178: 1318-1336, 2019. |
| ELAS | Andreas Geiger, Martin Roser, and Raquel Urtasun. Efficient large-scale stereo |
| | matching. ACCV 2010. Code. |
| MC-CNN-acrt | Jure Zbontar and Yann LeCun. Stereo matching by training a convolutional neural |
| | network to compare image patches (accurate architecture). JMLR 17: 1-32, 2016. |
| | Code. |
| MeshStereo | Chi Zhang, Zhiwei Li, Yanhua Cheng, Rui Cai, Hongyang Chao, and Yong Rui. |
| | MeshStereo: A global stereo model with mesh alignment regularization for view |
| | interpolation. ICCV 2015. |
| TMAP | Eric Psota, Jedrzej Kowalczuk, Mateusz Mittek, and Lance Perez. MAP disparity |
| | estimation using hidden Markov trees. ICCV 2015. |
| PFS | Cevahir Cigla and Aydin Alatan. Information permeability for stereo matching. Signal |
| | Processing: Image Communication 28(9), 2013. |
| REAF | Cevahir Cigla. Recursive edge-aware filters for stereo matching. CVPR Embedded |
| | Vision Workshop 2015. |
| TSGO | Mikhail Mozerov and Joost van de Weijer. Accurate stereo matching by two-step |
| | energy minimization. IEEE TIP 24(3): 1153-1163, 2015. |
| IDR | Jedrzej Kowalczuk, Eric Psota, and Lance Perez. Real-time stereo Matching on |
| | CUDA using an iterative refinement method for adaptive support-weight |
| | correspondences. IEEE TCSVT 23(1): 94-104, 2013. |
| SNCC | Nils Einecke and Julian Eggert. A two-stage correlation method for stereoscopic |
| | depth estimation. DICTA 2010. |
| LAMC_DSM | Christos Stentoumis, Lazaros Grammatikopoulos, Ilias Kalisperakis, and George |
| | Karras. On accurate dense stereo-matching using a local adaptive multi-cost |
| | approach. ISPRS Journal of Photogrammetry and Remote Sensing 91: 29-49, 2014. |
| BSM | Kang Zhang, Jiyang Li, Yijing Li, Weidong Hu, Lifeng Sun, and Shiqiang Yang. |
| | Binary stereo matching. ICPR 2012. |
| LPS | Sudipta Sinha, Daniel Scharstein, and Richard Szeliski. Efficient high-resolution |
| | stereo matching using local plane sweeps. CVPR 2014. |
| LPS | Sudipta Sinha, Daniel Scharstein, and Richard Szeliski. Efficient high-resolution |
| | stereo matching using local plane sweeps. CVPR 2014. |
| SGM | Heiko Hirschmüller. Stereo processing by semi-global matching and mutual |
| | information. CVPR 2006; PAMI 30(2): 328-341, 2008. |
| SGM | Heiko Hirschmüller. Stereo processing by semi-global matching and mutual |
| | information. CVPR 2006; PAMI 30(2): 328-341, 2008. |
| SGBM1 | OpenCV 2.4.8 StereoSGBM method, single-pass variant. Reimplementation and |
| | modification of H. Hirschmüller's SGM method (CVPR 2006; PAMI 2008). |
| Cens5 | Heiko Hirschmüller, Peter Innocent, and Jon Garibaldi. Real-time correlation-based |
| | stereo vision with reduced border errors. IJCV 47(1-3): 229-246, 2002. |
| SGBM1 | OpenCV 2.4.8 StereoSGBM method, single-pass variant. Reimplementation and |
| | modification of H. Hirschmüller's SGM method (CVPR 2006; PAMI 2008). |
| SGM | Heiko Hirschmüller. Stereo processing by semi-global matching and mutual |
| | information. CVPR 2006; PAMI 30(2): 328-341, 2008. |
| SGBM1 | OpenCV 2.4.8 StereoSGBM method, single-pass variant. Reimplementation and |
| | modification of H. Hirschmüller's SGM method (CVPR 2006; PAMI 2008). |
| SGBM2 | OpenCV 2.4.8 StereoSGBM method, full variant (2 passes). Reimplementation of |
| | H. Hirschmüller's SGM method (CVPR 2006; PAMI 2008). |

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the disclosed embodiment.

What is claimed is:

1. An autonomous guided vehicle comprising:
a frame with a payload hold;
a drive section coupled to the frame with drive wheels supporting the autonomous guided vehicle on a traverse surface, the drive wheels effect vehicle traverse on the traverse surface moving the autonomous guided vehicle over the traverse surface in a facility;
a payload handler coupled to the frame configured to transfer a payload, with a flat undeterministic seating surface seated in the payload hold, to and from the payload hold of the autonomous guided vehicle and a storage location, of the payload, in a storage array;
a vision system mounted to the frame, having more than one camera disposed to generate binocular images of a field of a logistic space including rack structure shelving on which more than one objects are stored; and
a controller, communicably connected to the vision system so as to register the binocular images, and configured to effect stereo matching, from the binocular images, resolving a dense depth map of imaged objects in the field, and the controller is configured to detect from the binocular images, stereo sets of keypoints, each set of keypoints setting out, separate and distinct from each other set, a common predetermined characteristic of each imaged object, so that the controller determines from the stereo sets of keypoints depth resolution of each object separate and distinct from the dense depth map;
wherein the controller has an object extractor configured to determine location and pose of each imaged object from both the dense depth map resolved from the binocular images and the depth resolution from the stereo sets of keypoints.

2. The autonomous guided vehicle of claim 1, wherein the more than one camera are rolling shutter cameras.

3. The autonomous guided vehicle of claim 1, wherein the more than one camera generate a video stream and the registered images are parsed from the video stream.

4. The autonomous guided vehicle of claim 1, wherein the more than one camera are unsynchronized with each other.

5. The autonomous guided vehicle of claim 1, wherein the binocular images are generated with the vehicle in motion past the objects.

6. The autonomous guided vehicle of claim 1, wherein the more than one objects on the racks structure are dynamically positioned in closely packed juxtaposition with respect to each other.

7. The autonomous guided vehicle of claim 1, wherein the controller is configured to determine a front face, of at least one extracted object, and dimensions of the front face.

8. The autonomous guided vehicle of claim 7, wherein the controller is configured to characterize a planar surface of the front face, and orientation of the planar surface relative to a predetermined reference frame.

9. The autonomous guided vehicle of claim 8, wherein the controller is configured to characterize a pick surface, of the extracted object based on characteristics of the planar surface, that interfaces the payload handler.

10. The autonomous guided vehicle of claim 8, wherein the controller is configured to resolve presence and characteristics of an anomaly to the planar surface.

11. The autonomous guided vehicle of claim 7, wherein the controller is configured to determine a logistic identity of the extracted object based on dimensions of the front face.

12. The autonomous guided vehicle of claim 1, wherein the controller is configured to generate at least one of an execute command and a stop command of a bot actuator based on the determined location and pose.

13. An autonomous guided vehicle comprising:
a frame with a payload hold;
a drive section coupled to the frame with drive wheels supporting the autonomous guided vehicle on a traverse surface, the drive wheels effect vehicle traverse on the traverse surface moving the autonomous guided vehicle over the traverse surface in a facility;
a payload handler coupled to the frame configured to transfer a payload, with a flat undeterministic seating surface seated in the payload hold, to and from the payload hold of the autonomous guided vehicle and a storage location, of the payload, in a storage array;
a vision system mounted to the frame, having binocular imaging cameras generating binocular images of a field of a logistic space including rack structure shelving on which more than one objects are stored; and
a controller, communicably connected to the vision system so as to register the binocular images, and configured to effect stereo matching, from the binocular images, resolving a dense depth map of imaged objects in the field, and the controller is configured to detect from the binocular images, stereo sets of keypoints, each set of keypoints setting out, separate and distinct from each other set of keypoints, a common predetermined characteristic of each imaged object, so that the controller determines from the stereo sets of keypoints depth resolution of each object separate and distinct from the dense depth map;
wherein the controller has an object extractor configured to identify location and pose of each imaged object based on superpose of stereo sets of keypoints depth resolution and depth map.

14. The autonomous guided vehicle of claim 13, wherein the more than one camera are rolling shutter cameras.

15. The autonomous guided vehicle of claim 13, wherein the more than one camera generate a video stream and the registered images are parsed from the video stream.

16. The autonomous guided vehicle of claim 13, wherein the more than one camera are unsynchronized with each other.

17. The autonomous guided vehicle of claim 13, wherein the binocular images are generated with the vehicle in motion past the objects.

18. The autonomous guided vehicle of claim 13, wherein the more than one objects on the racks structure are dynamically positioned in closely packed juxtaposition with respect to each other.

19. The autonomous guided vehicle of claim 13, wherein the controller is configured to determine a front face, of at least one extracted object, and dimensions of the front face.

20. The autonomous guided vehicle of claim 19, wherein the controller is configured to characterize a planar surface of the front face, and orientation of the planar surface relative to a predetermined reference frame.

21. The autonomous guided vehicle of claim 20, wherein the controller is configured to characterize a pick surface, of the extracted object based on characteristics of the planar surface, that interfaces the payload handler.

22. The autonomous guided vehicle of claim 20, wherein the controller is configured to resolve presence and characteristics of an anomaly to the planar surface.

23. The autonomous guided vehicle of claim 19, wherein the controller is configured to determine a logistic identity of the extracted object based on dimensions of the front face.

24. The autonomous guided vehicle of claim 13, wherein the controller is configured to generate at least one of an execute command and a stop command of a bot actuator based on the identified location and pose.
